(19) United States
(12) Patent Application Publication
(10) Pub. No.: US 2018/0011671 A1
(43) Pub. Date: Jan. 11, 2018

(54) SERVER, ITEM PROVIDING SYSTEM, DISPLAY DEVICE, MOBILE TERMINAL, AND CONTROL PROGRAM

(71) Applicant: Sharp Kabushiki Kaisha, Sakai City, Osaka (JP)

(72) Inventor: SUNAO YAMAGUCHI, Sakai City (JP)

(21) Appl. No.: 15/527,681

(22) PCT Filed: Nov. 17, 2015
(86) PCT No.: PCT/JP2015/082264

§ 371 Date: May 17, 2017

(30) Foreign Application Priority Data
Nov. 21, 2014 (JP) 2014-237165

(51) Int. Cl. G06F 3/14; G09G 3/00; G06Q 30/02

(52) U.S. Cl. CPC G06F 3/14; G09G 3/001; G06Q 30/02

(57) ABSTRACT

Provided is a technique with which it is possible to intuitively notify a user that the user has acquired an item or a right to acquire the item. A server (100) includes: an image output unit (124) that outputs an item presentation image; and an information acquisition unit (121) that acquires acquisition operation receiving information indicating that an acquisition operation of acquiring at least one of a target item and a right to acquire the target item has been received, and when the acquisition operation receiving information is acquired, outputs an item acquisition complete image indicating that at least one of the target item and the right to acquire the target item has been acquired.

### TECHNICAL FIELD

The present invention relates to a server that provides an item, an item providing system, a display device, a mobile terminal that acquires the item, a control program causing a computer to function as the server, and a control program causing a computer to function as the mobile terminal.

### BACKGROUND ART

With the spread of mobile terminals, a sales promotion method of distributing an electronic coupon, which is a coupon in electronic form, for granting a reward such as a product discount or gift presentation has been widely used. Thus, techniques with which such electronic coupons are distributed to many users have been disclosed.

For example, PTL 1 discloses a technique in which a mobile terminal is held over an electronic coupon exchanging terminal and buttons that are arranged in the same manner as a plurality of coupons displayed on a display screen of the electronic coupon exchanging terminal are displayed on the mobile terminal. With this configuration, a desired coupon may be selected by performing a single key operation in PTL 1.

Moreover, PTL 2 discloses a technique in which when a user performs an operation in such a manner that a coupon displayed on a display screen is scooped by a mobile terminal, the coupon is transferred to the mobile terminal.

### CITATION LIST

### Patent Literature

PTL 1: Japanese Unexamined Patent Application Publication No. 2010-237917 (published on Oct. 21, 2010)

PTL 2: Japanese Unexamined Patent Application Publication No. 2014-35657 (published on Feb. 24, 2014)

### SUMMARY OF INVENTION

### Technical Problem

However, with the related art techniques described above, even when an electronic coupon or a coupon has been acquired, display of the electronic coupon exchanging terminal on which the electronic coupon is displayed or the display on which the coupon is displayed does not change. In other words, it is difficult for the user to know whether or not the electronic coupon or the coupon has been acquired even by seeing the display on the electronic coupon exchanging terminal or the display. Thus, the related art techniques described above have a problem that it is difficult to intuitively notify the user that the user has acquired the electronic coupon or the coupon.

The invention has been made in view of the aforementioned problem, and an object thereof is to provide a technique with which it is possible to intuitively notify a user that the user has acquired an item or a right to acquire the item.

### Solution to Problem

In order to solve the aforementioned problem, a server according to an aspect of the invention includes: an image output unit that outputs, to a display device, an item presentation image indicating one or more items; and an acquisition unit that acquires acquisition operation receiving information indicating that the display device has received an acquisition operation that is an operation of acquiring at least one of a target item of the one or more items and a right to acquire the target item, in which when the acquisition unit acquires the acquisition operation receiving information, the image output unit outputs an item acquisition complete image indicating that at least one of the target item and the right to acquire the target item has been acquired.

In order to solve the aforementioned problem, a control program according to an aspect of the invention is a control program causing a computer to function as a server, in which the computer is caused to function as an image output unit that outputs, to a display device, an item presentation image indicating one or more items, and an acquisition unit that acquires acquisition operation receiving information indicating that the display device has received an acquisition operation that is an operation of acquiring at least one of a target item of the one or more items and a right to acquire the target item, and when the acquisition unit acquires the acquisition operation receiving information, the image output unit outputs an item acquisition complete image indicating that at least one of the target item and the right to acquire the target item has been acquired.

In order to solve the aforementioned problem, an item providing system according to an aspect of the invention is an item providing system including a mobile terminal, a display device, and a server, in which the mobile terminal includes: an item acquisition unit that acquires, with an acquisition operation that is an operation of acquiring at least one of a target item of one or more items and a right to acquire the target item, the item or the right to acquire the item from the display device; the display device includes an image acquisition unit that acquires an item presentation image indicating the one or more items, an image display unit that displays, on a display unit, the item presentation image acquired by the image acquisition unit, an acquisition operation reception unit that receives the acquisition operation, and an information output unit that, when the acquisition operation reception unit receives the acquisition operation, outputs acquisition operation receiving information indicating that the acquisition operation has been received; and the server includes an image output unit that outputs the item presentation image to the display device, and an acquisition unit that acquires the acquisition operation receiving information from the display device, and when the acquisition unit acquires the acquisition operation receiving information, the image output unit outputs an item acquisition complete image indicating that at least one of the target item and the right to acquire the target item has been acquired.

In order to solve the aforementioned problem, a display device according to an aspect of the invention includes: an image display unit that displays, on a display unit, an item presentation image indicating one or more items; and an acquisition operation reception unit that receives an acquisition operation that is an operation of acquiring at least one of a target item of the one or more items and a right to acquire the target item, and when the acquisition operation reception unit receives the acquisition operation, the image display unit displays, on the display unit, an item acquisition complete image indicating that at least one of the target item and the right to acquire the target item has been acquired.

In order to solve the aforementioned problem, a control program according to an aspect of the invention is a control program causing a computer to function as a display device, in which the computer is caused to function as an image display unit that displays, on a display unit, an item presentation image indicating one or more items; and an acquisition operation reception unit that receives an acquisition operation that is an operation of acquiring at least one of a target item of the one or more items and a right to acquire the target item, and when the acquisition operation reception unit receives the acquisition operation, the image display unit displays, on the display unit, an item acquisition complete image indicating that at least one of the target item and the right to acquire the target item has been acquired.

In order to solve the aforementioned problem, a mobile terminal according to an aspect of the invention is a mobile terminal, including: an acquisition operation detection unit that detects, through near field radio communication, an acquisition operation that is an operation of acquiring at least one of a target item of one or more items and a right to acquire the target item; and an item acquisition unit that, when the acquisition operation detection unit detects the acquisition operation, acquires at least one of the target item and the right to acquire the target item.

In order to solve the aforementioned problem, a control program according to an aspect of the invention is a control program causing a computer to function as a mobile terminal, in which the computer is caused to function as an acquisition operation detection unit that detects, through near field radio communication, an acquisition operation that is an operation of acquiring at least one of a target item of one or more items and a right to acquire the target item; and an item acquisition unit that, when the acquisition operation detection unit detects the acquisition operation, acquires at least one of the target item and the right to acquire the target item.

### Advantageous Effects of Invention

According to an aspect of the invention, it is possible to intuitively notify a user that the user has acquired an item or a right to acquire the item.

### BRIEF DESCRIPTION OF DRAWINGS

FIG. 1 schematically illustrates an item providing system according to Embodiment 1 of the invention.

FIG. 2 illustrates a configuration of a server in Embodiment 1 of the invention, in which (a) is a block diagram illustrating a configuration of a main part of the server and (b) illustrates a hardware configuration of the server.

FIG. 3 illustrates a configuration of a display device in Embodiment 1 of the invention, in which (a) is a block diagram illustrating a configuration of a main part of the display device and (b) illustrates a hardware configuration of the display device.

FIG. 4 illustrates a configuration of a mobile terminal in Embodiment 1 of the invention, in which (a) is a block diagram illustrating a configuration of a main part of the mobile terminal and (b) illustrates a hardware configuration of the mobile terminal.

FIG. 5 is a sequence view illustrating a flow of item providing processing in the item providing system according to Embodiment 1 of the invention.

FIG. 6 illustrates an example of an item presentation image displayed by the display device in Embodiment 1 of the invention.

FIG. 7 illustrates an example of an acquisition operation in the item providing system according to Embodiment 1 of the invention, in which (a) illustrates a state where the mobile terminal is in proximity to a target item and (b) illustrates a state where the mobile terminal is displaced from the target item.

FIG. 8 is a sequence view illustrating a flow of item selection processing in the item providing system according to Embodiment 1 of the invention.

FIG. 9 illustrates an example of a selection operation in the item providing management system according to Embodiment 1 of the invention, in which (a) illustrates a state where the mobile terminal is in proximity to a coupon, (b) illustrates a state where the coupon is selected, and (c) illustrates a state where a coupon is selected.

FIG. 10 is a sequence view illustrating a flow of item acquisition cancellation processing in the item providing system according to Embodiment 1 of the invention.

FIG. 11 illustrates an example of a cancellation operation in the item providing management system according to Embodiment 1 of the invention, in which (a) illustrates a state where item information acquired by the mobile terminal is displayed, (b) illustrates an operation of moving the mobile terminal into proximity to the display device, and (c) illustrates the mobile terminal and the display device after the cancellation operation.

FIG. 12 schematically illustrates an item providing system according to Embodiment 2 of the invention.

FIG. 13 is a sequence view illustrating a flow of item acquisition right providing processing in the item providing system according to Embodiment 2 of the invention.

FIG. 14 schematically illustrates an item providing system according to Embodiment 3 of the invention.

FIG. 15 is a sequence view illustrating a flow of item providing processing in the item providing system according to Embodiment 3 of the invention.

FIG. 16 schematically illustrates an item providing system according to Embodiment 4 of the invention.

FIG. 17 is a sequence view illustrating a flow of item providing processing in the item providing system according to Embodiment 4 of the invention.

FIG. 18 schematically illustrates an item providing system according to Embodiment 5 of the invention.

FIG. 19 is a sequence view illustrating a flow of item providing processing in the item providing system according to Embodiment 5 of the invention.

FIG. 20 schematically illustrates an item providing system according to Embodiment 6 of the invention.

FIG. 21 is a block diagram illustrating a configuration of a main part of a display device according to Embodiment 6 of the invention.

FIG. 22 is a sequence view illustrating a flow of item providing processing in the item providing system according to Embodiment 6 of the invention.

### DESCRIPTION OF EMBODIMENTS

### Embodiment 1

Hereinafter, an embodiment of the invention will be described in detail. Configurations other than configurations which are described in the specific embodiments below may be omitted from the description as needed but are the same as configurations which are described in other embodiments. Further, for convenience of description, the same reference signs are assigned to members having the same functions as those of members indicated in each of the embodiments, and description thereof will be omitted as appropriate.

### (Item Providing System 1)

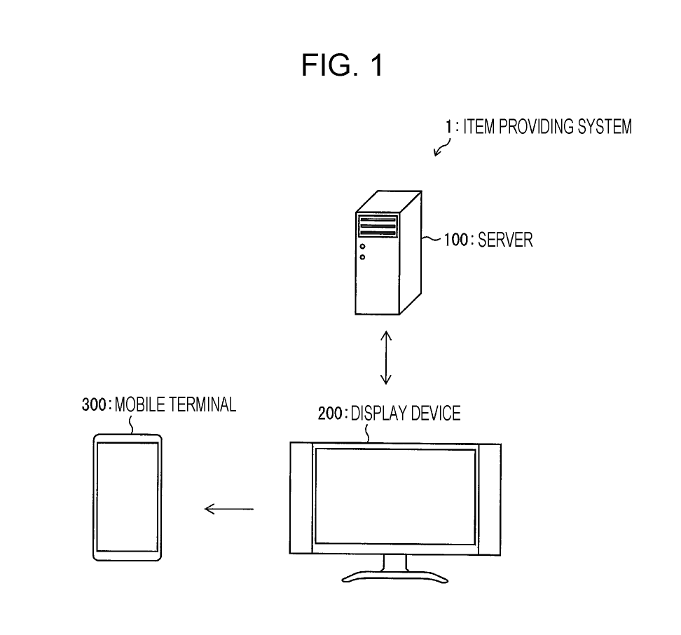

FIG. 1 schematically illustrates an item providing system 1 according to Embodiment 1 of the invention. The item providing system 1 includes a server 100, a display device 200, and a mobile terminal 300 as illustrated in FIG. 1.

In the item providing system 1, the server 100 outputs, to the display device 200, an item presentation image indicating one or more items. The display device 200 displays the item presentation image from the server 100, receives an acquisition operation that is an operation with which the mobile terminal 300 acquires at least one of a target item of the one or more items indicated by the item presentation image and a right to acquire the target item, and outputs, to the server 100, acquisition operation receiving information indicating reception of the acquisition operation. Upon acquisition of the acquisition operation receiving information, the server 100 outputs, to the display device 200, an item acquisition complete image indicating that at least one of the target item and the right to acquire the target item has been acquired.

Note that, although the “acquisition operation” in the invention is not particularly limited, the acquisition operation in the present specification is set as an operation in which the mobile terminal 300 is displaced from the display device 200 after the mobile terminal 300 has been in proximity to the target item displayed on the display device 200. The “displacing operation” includes an operation of displacement in a vertical direction with respect to a display surface of the display device 200, an operation of displacement in a display plane direction of the display device 200, and a displacing operation as a combination thereof. A method of detecting the acquisition operation with the display device 200 and the mobile terminal 300 will be described later.

In the present specification, an “item” is only required to be electronic data, and an electronic coupon is provided as an example, but the “item” is not limited thereto and may be, for example, image data, moving image data, an application, or the like. Although item storage location information (more specifically, a URL (Uniform Resource Locator)) indicating a storage location at which the item is stored is provided as an example of the “right to acquire the item”, it is not limited thereto and may be, for example, item exchange data (more specifically, data by which the item is able to be acquired by holding a smartphone, which has acquired the item exchange data, over a device that is installed in a predetermined place) that is a right by which the item is able to be acquired at the predetermined place, point data (more specifically, data that indicates points which are used to acquire the item and by which the item is able to be acquired when predetermined points are saved), or the like.

The mobile terminal 300 in the invention is only required to be configured to acquire at least one of the target item and the right to acquire the target item, and description will be given in the present embodiment for the mobile terminal 300 configured to acquire the target item. Noe that, the configuration in which the mobile terminal 300 acquires at least one of the target item and the right to acquire the target item is able to be implemented by substituting the “target item” with the “right to acquire the target item” in the present embodiment.

### (Server 100)

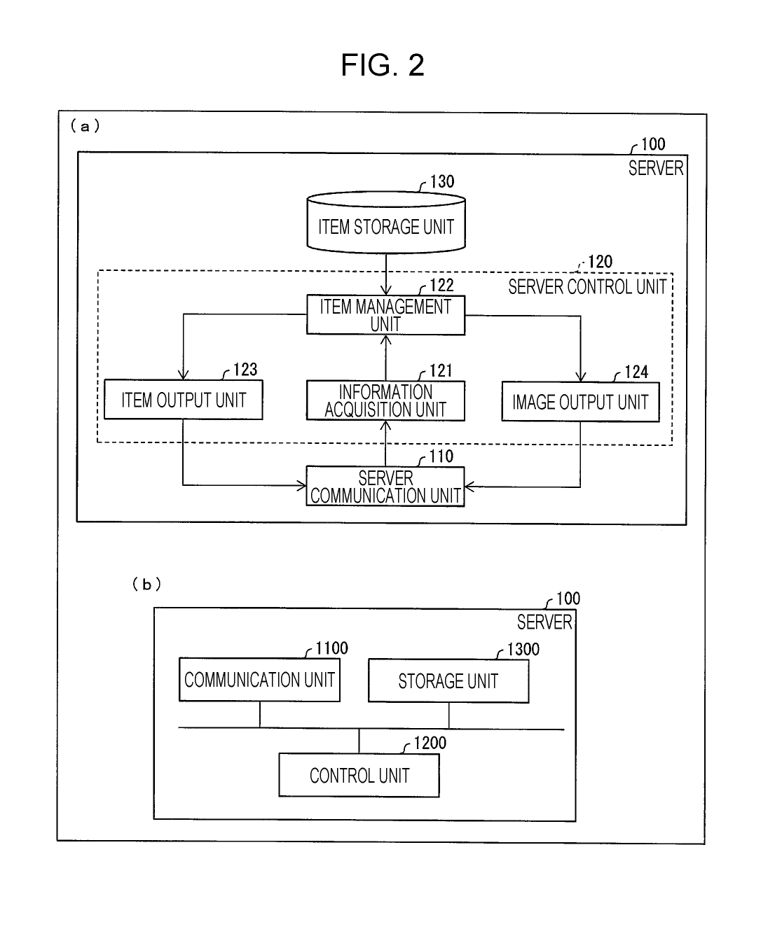

FIG. 2 illustrates a configuration of the server 100 in Embodiment 1 of the invention, in which (a) is a block diagram illustrating a configuration of a main part of the server 100 and (b) illustrates a hardware configuration of the server 100. The server 100 will be described with the use of FIG. 2.

The server 100 includes a server communication unit 110, a server control unit 120, and an item storage unit 130 as illustrated in FIG. 2(a).

The server communication unit 110 is able to transmit or receive information to and from external equipment.

In the item storage unit 130, one or more items are stored.

The server control unit 120 integrally controls the components of the server 100. The server control unit 120 will be described in detail below.

### (Server Control Unit 120)

The server control unit 120 functions also as an information acquisition unit (acquisition unit) 121, an item management unit 122, an item output unit 123, and an image output unit 124 as illustrated in FIG. 2(a).

The information acquisition unit 121 controls the server communication unit 110 and acquires information output from the display device 200 or the mobile terminal 300.

The item management unit 122 manages an item to be provided to the mobile terminal 300. Processing of managing the item by the item management unit 122 will be described in detail below.

The item output unit 123 controls the server communication unit 110 and outputs, to at least one of the display device 200 and the mobile terminal 300, the item output from the item management unit 122.

In accordance with a request from the item management unit 122, the image output unit 124 outputs at least one of an item presentation image indicating one or more items, an item acquisition complete image indicating that at least one of a target item and a right to acquire the target item has been acquired, and an item selection complete image indicating that an item is selected.

### (Hardware Configuration of Server 100)

A hardware configuration of the server 100 will be described with the use of FIG. 2(b). The server 100 includes a communication unit 1100, a control unit 1200, and a storage unit 1300 as illustrated in FIG. 2(b).

The communication unit 1100 is an interface that enables communication with external equipment. The communication unit 1100 implements the aforementioned function of the server communication unit 110.

The storage unit 1300 is a device having a function of storing acquired information. The storage unit 1300 implements the aforementioned function of the item storage unit 130. The storage unit 1300 includes a main storage unit and an auxiliary storage unit. An example of a device that may be used as the main storage unit of the storage unit 1300 includes a semiconductor RAM (random access memory). An example of a device that may be used as the auxiliary storage unit of the storage unit 1300 includes a hard disc drive (HDD), and a control program for running as the server 100 is stored in the auxiliary storage unit. The control program is a program for implementing the function of the server control unit 120.

The control unit 1200 loads a control program into the main storage of the storage unit 1300 and executes various instructions included in the loaded control program to thereby implement the aforementioned function of the server control unit 120. As a device that may be used as the control unit 1200, there is a CPU (Central Processing Unit).

### (Display Device 200)

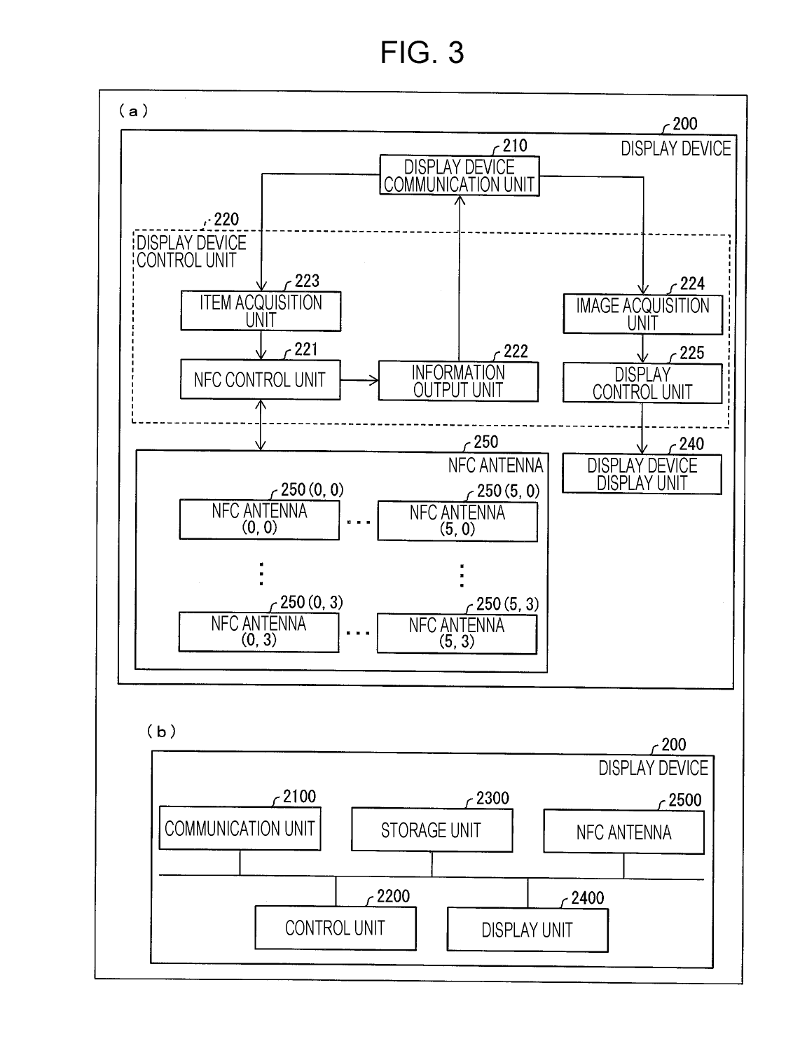

FIG. 3 illustrates a configuration of the display device 200 in Embodiment 1 of the invention, in which (a) is a block diagram illustrating a configuration of a main part of the display device 200 and (b) illustrates a hardware configuration of the display device 200. The display device 200 will be described with the use of FIG. 3.

The display device 200 includes a display device communication unit 210, a display device control unit 220, a display device display unit 240, and an NFC (Near Field Communication) antenna 250 as illustrated in FIG. 3.

The display device communication unit 210 is able to transmit or receive information to or from external equipment.

The display device display unit 240 displays an image indicated by an image signal output from the display device control unit 220.

The NFC antenna 250 performs NFC communication with the mobile terminal 300 (more specifically, an NFC-I/F unit 350, which will be described later, of the mobile terminal 300). Information desired to be transmitted to the mobile terminal 300 is able to be set to the NFC antenna 250. The NFC antenna 250 is formed of a plurality of NFC antennas (such as an NFC antenna 250(0,0) and an NFC antenna 250(5,3)) as illustrated in FIG. 3(a). Note that, although the number of antennas forming the NFC antenna 250 is 24 in the present embodiment, the number and arrangement positions of the antennas forming the NFC antenna 250 are not particularly limited.

The display device control unit 220 integrally controls the components of the display device 200. The display device control unit 220 will be described in detail below.

### (Display Device Control Unit 220)

The display device control unit 220 functions also as an NFC control unit (acquisition operation reception unit) 221, an information output unit 222, an item acquisition unit 223, an image acquisition unit 224, and a display control unit (image display unit) 225 as illustrated in FIG. 3(a).

The NFC control unit 221 controls NFC communication performed via the NFC antenna 250. Processing of controlling the NFC communication by the NFC control unit 221 will be described in detail below.

The information output unit 222 outputs at least one of acquisition operation receiving information indicating that the display device 200 has received an acquisition operation, selected item information indicating that a selection operation has been received, and cancel information indicating that acquisition of a target item has been canceled.

The item acquisition unit 223 controls the display device communication unit 210 and acquires an item output from the server 100.

The image acquisition unit 224 controls the display device communication unit 210 and outputs at least one of an item presentation image, an item acquisition complete image, and an item selection complete image that are output from the server 100.

The display control unit 225 outputs, to the display device display unit 240, an image signal indicating at least one of the item presentation image, the item acquisition complete image, and the item selection complete image that are acquired by the image acquisition unit 224.

### (Hardware Configuration of Display Device 200)

The hardware configuration of the display device 200 will be described with the use of FIG. 3(b). The display device 200 includes a communication unit 2100, a control unit 2200, a storage unit 2300, a display unit 2400, and an NFC antenna 2500 as illustrated in FIG. 3(b).

The communication unit 2100 is an interface that enables communication with external equipment. The communication unit 2100 implements the aforementioned function of the display device communication unit 210.

The storage unit 2300 is a device having a function of storing acquired information and includes a main storage unit and an auxiliary storage unit. An example of a device that may be used as the main storage unit of the storage unit 2300 includes a semiconductor RAM. An example of a device that may be used as the auxiliary storage unit of the storage unit 2300 includes a hard disc drive, and a control program to operate as the display device 200 is stored in the auxiliary storage unit. The control program is a program for implementing the function of the display device control unit 220. The storage unit 2300 implements a function of an item storage unit 230 described later.

The control unit 2200 loads a control program into the main storage of the storage unit 2300 and executes various instructions included in the loaded control program to thereby implement the aforementioned function of the display device control unit 220. As a device that may be used as the control unit 2200, there is a CPU.

The display unit 2400 outputs an image indicated by an image signal to a screen. Examples of the display unit 2400 include display devices such as an LCD (Liquid Crystal Display), a PDP (Plasma Display Panel), and an EL (Electroluminescence) display. The display unit 2400 implements the aforementioned function of the display device display unit 240.

The NFC antenna 2500 is a communication device for performing near field radio communication with the outside, and the NFC antenna 2500 is a sheet member provided to be superimposed on the display unit 2400. The NFC antenna 2500 realizes the aforementioned NFC antenna 250.

### (Mobile Terminal 300)

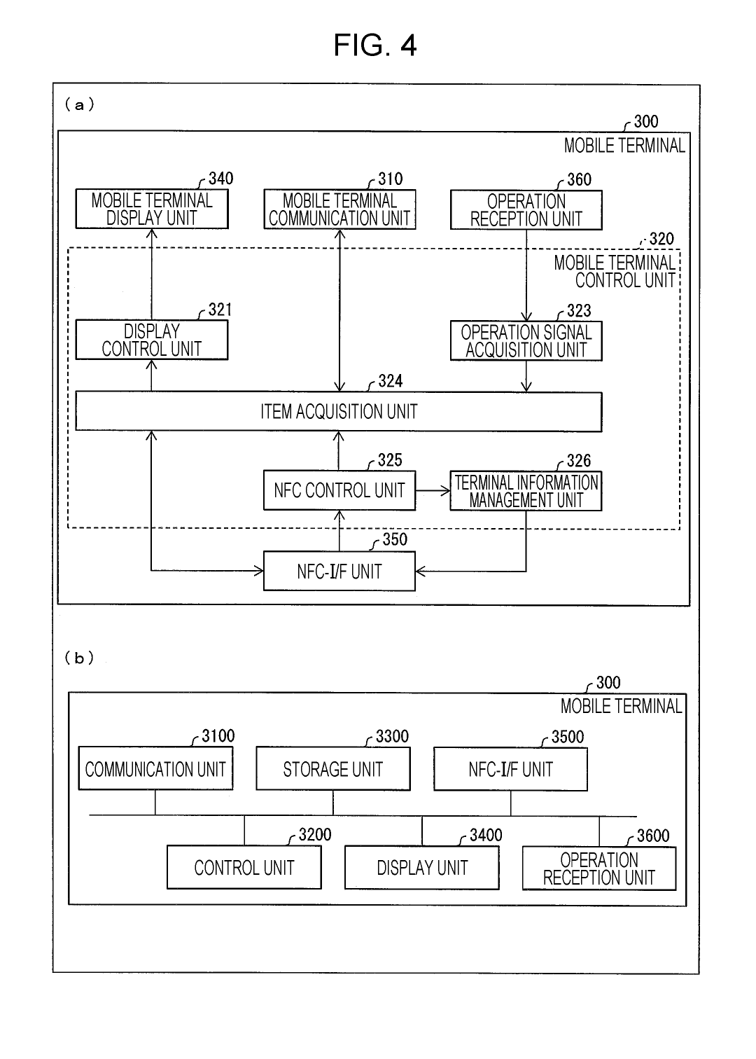

FIG. 4 illustrates a configuration of the mobile terminal 300 in Embodiment 1 of the invention, in which (a) is a block diagram illustrating a configuration of a main part of the mobile terminal 300 and (b) illustrates a hardware configuration of the mobile terminal 300. The mobile terminal 300 will be described with the use of FIG. 4.

The mobile terminal 300 includes a mobile terminal communication unit 310, a mobile terminal control unit 320, a mobile terminal display unit 340, an NFC interface unit (hereinafter, abbreviated as an “NFC-I/F unit”) 350, and an operation reception unit 360 as illustrated in FIG. 4.

The mobile terminal communication unit 310 is able to transmit or receive information to or from external equipment.

The mobile terminal display unit 340 displays an image indicated by an image signal output from the mobile terminal control unit 320.

The NFC-I/F unit 350 performs NFC communication with the display device 200 (more specifically, the NFC antenna 250).

The operation reception unit 360 is a device that receives an operation of a user.

The mobile terminal control unit 320 integrally controls the components of the mobile terminal 300. The mobile terminal control unit 320 will be described in detail below.

### (Mobile Terminal Control Unit 320)

The mobile terminal control unit 320 functions also as a display control unit 321, an operation signal acquisition unit 323, an item acquisition unit 324, an NFC control unit (acquisition operation detection unit) 325, and a terminal information management unit 326 as illustrated in FIG. 4(a).

The display control unit 321 outputs an image signal indicating an image to the mobile terminal display unit 340.

The operation signal acquisition unit 323 acquires, via the operation reception unit 360, an operation signal indicating an operation by the user.

The item acquisition unit 324 executes processing of acquiring an item. More specifically, the item acquisition unit 324 performs, for example, processing of acquiring a target item or a selection item that is a selected item, and details thereof will be described later.

The NFC control unit 325 controls NFC communication performed by the NFC-I/F unit 350.

The terminal information management unit 326 manages mobile terminal information that is information related to the mobile terminal 300. More specific examples of the mobile terminal information include model information of the mobile terminal 300, a notification destination (for example, such as an IP (Internet Protocol) address or a telephone number that is set to the mobile terminal 300) of the mobile terminal 300, a name, age, or sex of the user of the mobile terminal 300, but the mobile terminal information is not limited thereto.

### (Hardware Configuration of Mobile Terminal 300)

The hardware configuration of the mobile terminal 300 will be described with the use of FIG. 4(b). The mobile terminal 300 includes a communication unit 3100, a control unit 3200, a storage unit 3300, a display unit 3400, an NFC-I/F unit 3500, and an operation reception unit 3600 as illustrated in FIG. 4(b).

The communication unit 3100 is an interface that enables communication with external equipment. The communication unit 3100 implements the aforementioned function of the mobile terminal communication unit 310.

The storage unit 3300 is a device having a function of storing acquired information and includes a main storage unit and an auxiliary storage unit. An example of a device that may be used as the main storage unit of the storage unit 3300 includes a semiconductor RAM. An example of a device that may be used as the auxiliary storage unit of the storage unit 3300 includes a hard disc drive, and a control program to operate as the mobile terminal 300 is saved in the auxiliary storage unit. The control program is a program for implementing the function of the mobile terminal control unit 320.

The control unit 3200 loads a control program into the main storage of the storage unit 3300 and executes various instructions included in the loaded control program to thereby implement the aforementioned function of the mobile terminal control unit 320. As a device that may be used as the control unit 3200, there is a CPU.

The display unit 3400 outputs an image indicated by an image signal to a screen. Examples of the display unit 3400 include display devices such as an LCD, a PDP, and an EL display. The display unit 3400 implements the aforementioned function of the mobile terminal display unit 340.

The NFC-I/F unit 3500 is a communication device for performing near field radio communication with the outside and implements the aforementioned function of the NFC-I/F unit 350.

The operation reception unit 3600 is a user interface that receives an operation from the user, and examples thereof include a switch and a hard key. The operation reception unit 3600 implements the aforementioned function of the operation reception unit 360.

### (Processing 1 of Item Providing System 1)

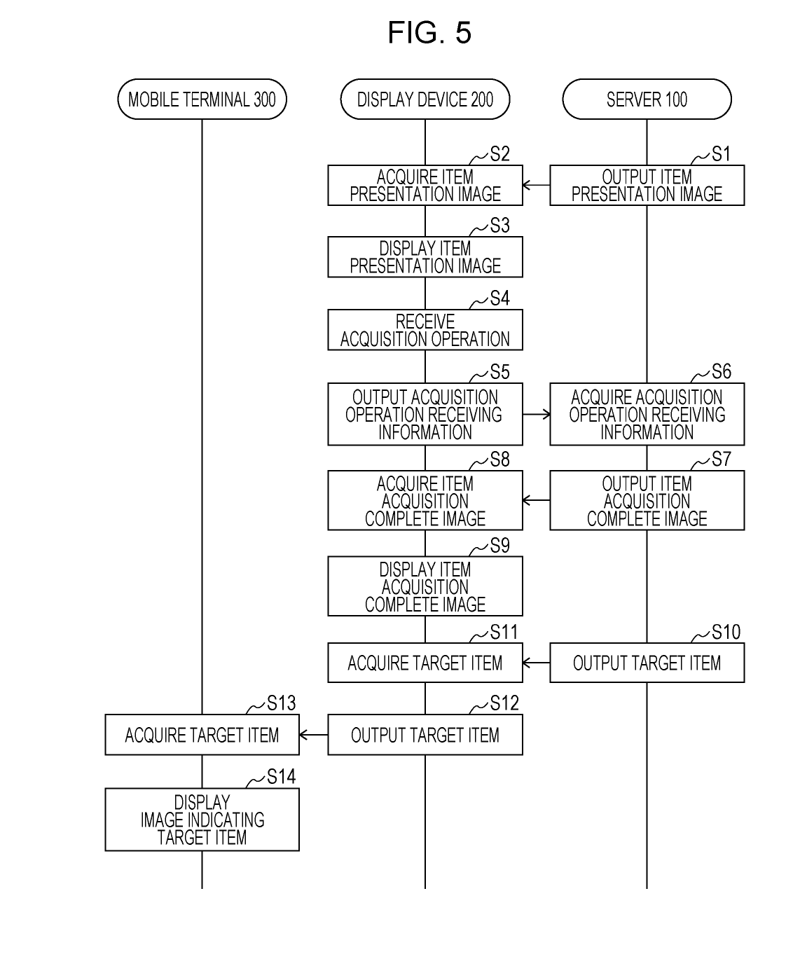

FIG. 5 is a sequence view illustrating a flow of item providing processing in the item providing system 1 according to Embodiment 1 of the invention. With the use of FIG. 5, description will be given for item providing processing that is processing up to display of an image indicating an acquired item by the mobile terminal 300 in the item providing system 1.

### (Step S1)

The item management unit 122 of the server 100 requests the image output unit 124 to output an item presentation image. Upon reception of the request, the image output unit 124 outputs the item presentation image to the display device 200 via the server communication unit 110.

### (Step S2)

Upon acquisition of the item presentation image via the display device communication unit 210, the image acquisition unit 224 of the display device 200 outputs the item presentation image to the display control unit 225.

### (Step S3)

The display control unit 225 acquires the item presentation image and outputs an image signal indicating the item presentation image to the display device display unit 240. Upon acquisition of the image signal output from the display control unit 225, the display device display unit 240 displays the item presentation image indicated by the image signal.

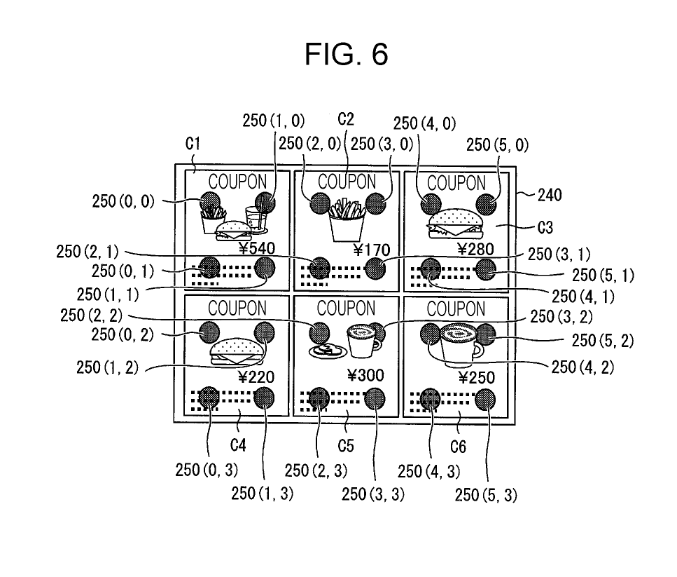

An example of the image displayed by the display device display unit 240 at step S3 is illustrated in FIG. 6. FIG. 6 illustrates an example of the item presentation image displayed by the display device 200 in Embodiment 1 of the invention.

As illustrated in FIG. 6, the display device display unit 240 displays an item presentation image indicating each of a coupon C1 to a coupon C6. As illustrated in FIG. 6, NFC antennas 250 are arranged in the display region of each of the coupons of the coupon C1 to the coupon C6. For example, the NFC antenna 250(0,0), the NFC antenna 250(1,0), the NFC antenna 250(0,1), and the NFC antenna 250(1,1) are arranged in the display region of the coupon C1.

### (Step S4)

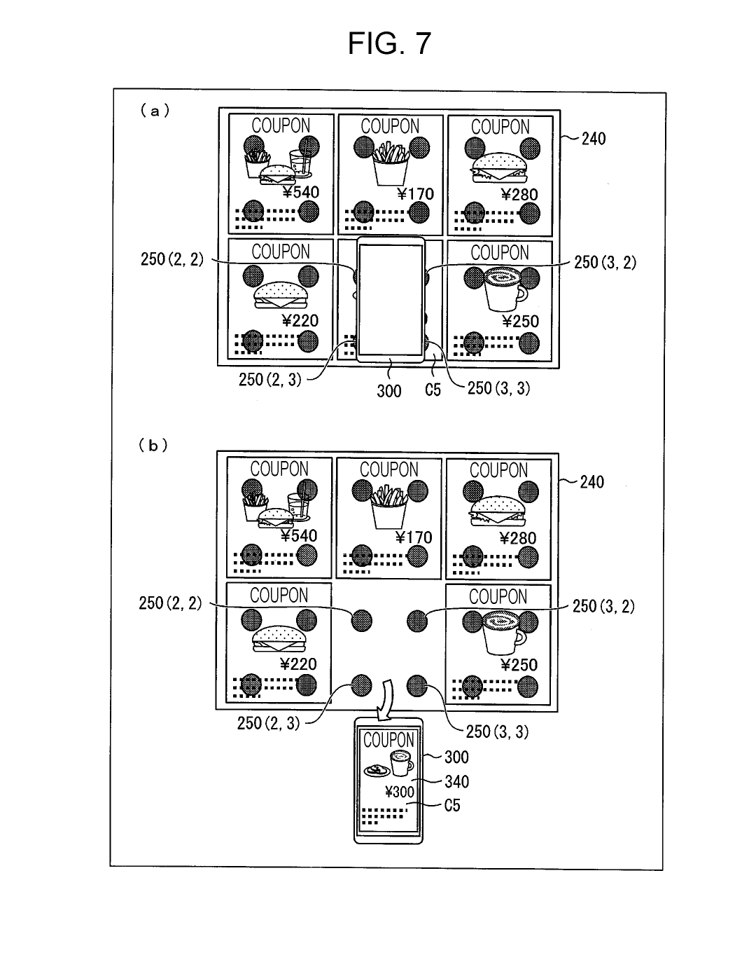

Subsequently, the NFC control unit 221 receives an acquisition operation that is an operation of acquiring a target item of one or more items indicated by the item presentation image displayed on the display device display unit 240. An example of a method of receiving the acquisition operation by the NFC control unit 221 will be described with the use of FIG. 7. FIG. 7 illustrates an example of an acquisition operation in the item providing system 1 according to Embodiment 1 of the invention, in which (a) illustrates a state where the mobile terminal 300 is in proximity to the coupon C5 (target item) and (b) illustrates a state where the mobile terminal 300 is displaced from the target item.

When the mobile terminal 300 is in proximity to the coupon C5 as illustrated in FIG. 7(a), any of the NFC antenna 250(2,2), the NFC antenna 250(3,2), the NFC antenna 250(2,3), and the NFC antenna 250(3,3) that are arranged in the region where the coupon 5 is displayed performs NFC communication with the NFC-I/F unit 350 of the mobile terminal 300. When detecting that any (for example, the NFC antenna 250(2,2)) of the NFC antenna 250(2,2), the NFC antenna 250(3,2), the NFC antenna 250(2,3), and the NFC antenna 250(3,3) performs NFC communication, the NFC control unit 221 determines that the mobile terminal 300 is in proximity to the coupon C5 displayed in the region in which the NFC antenna 250(2,2) is arranged.

Each of the NFC antennas 250 outputs, to the NFC control unit 221, a detection signal indicating that the NFC-I/F unit 350 is in proximity and a distance by which the NFC-I/F unit 350 is made proximate. For example, when the mobile terminal 300 is in proximity to the coupon C5 as illustrated in FIG. 7(a), the NFC control unit 221 acquires the detection signal from each of the NFC antenna 250(2,2), the NFC antenna 250(3,2), the NFC antenna 250(2,3), and the NFC antenna 250(3,3). In such a state, the NFC antenna 250(2,2) and the NFC antenna 250(3,2) respectively output a detection signal A and a detection signal B, and when a value of the detection signal A is greater than a value of the detection signal B, the NFC control unit 221 determines that the NFC-I/F unit 350 is in proximity to the NFC antenna 250(2,2) and the NFC antenna 250(3,2) and is in proximity to the NFC antenna 250(2,2) more than the NFC antenna 250(3,2).

When the mobile terminal 300 is displaced from the coupon C5 as illustrated in FIG. 7(b), communication intensity of the NFC communication between the NFC antenna 250(2,2) and the mobile terminal 300 is reduced. The NFC control unit 221 determines whether or not the communication intensity of the NFC communication of the NFC antenna 250(2,2) that has performed the NFC communication is smaller than a predetermined value and a value of the detection signal output from other NFC antennas 250 is reduced. In other words, whether or not the mobile terminal 300 is displaced from the display surface of the display device 200 is determined. When determining that the communication intensity of the NFC communication of the NFC antenna 250(2,2) is smaller than the predetermined value and the value of the detection signal output from other NFC antennas 250 is reduced, the NFC control unit 221 determines that the mobile terminal 300 is displaced. The NFC control unit 221 then receives an acquisition operation that is an operation of acquiring the coupon C5. Note that, the NFC control unit 221 may be configured to determine whether no detection signal is acquired from the NFC antenna 250 that has output the detection signal and no detection signal is acquired from other NFC antennas 250, instead of determining whether or not the value of the detection signal is reduced.

As another method, when the mobile terminal 300 is displaced from the coupon C5 as illustrated in FIG. 7(b) while the NFC control unit 221 acquires the detection signal from each of the NFC antenna 250(2,2), the NFC antenna 250(3,2), the NFC antenna 250(2,3), and the NFC antenna 250(3,3) as illustrated in FIG. 7(a), the detection signal output from each of the NFC antenna 250(2,2), the NFC antenna 250(3,2), the NFC antenna 250(2,3), and the NFC antenna 250(3,3) becomes weak. The NFC control unit 221 then determines whether or not the detection signal output from each of the NFC antenna 250(2,2), the NFC antenna 250(3,2), the NFC antenna 250(2,3), and the NFC antenna 250(3,3) has a value smaller than a predetermined value. When the NFC control unit 221 determines that the detection signal output from each of the NFC antenna 250(2,2), the NFC antenna 250(3,2), the NFC antenna 250(2,3), and the NFC antenna 250(3,3) has a value smaller than the predetermined value and no detection signal is acquired from other NFC antennas 250, the NFC control unit 221 determines that the mobile terminal 300 is displaced. Further, the NFC control unit 221 receives the acquisition operation that is an operation of acquiring the coupon C5. Note that, the NFC control unit 221 may not be configured to determine whether or not each of the detection signals output from the NFC antennas 250 has a value smaller than the predetermined value and may be configured to determine whether or not an average value of the detection signals output from the NFC antennas 250 is smaller than a predetermined value.

### (Step S5)

The NFC control unit 221 notifies the information output unit 222 that the acquisition operation has been received. Upon reception of the notification, the information output unit 222 outputs, to the server 100 via the display device communication unit 210, acquisition operation receiving information indicating that the acquisition operation has been received.

### (Step S6)

The information acquisition unit 121 of the server 100 acquires the acquisition operation receiving information via the server communication unit 110. The information acquisition unit 121 then outputs the acquisition operation receiving information to the item management unit 122.

### (Step S7)

Upon acquisition of the acquisition operation receiving information, the item management unit 122 refers to the acquisition operation receiving information and requests the image output unit 124 to output an item acquisition complete image indicating that a target item has been acquired. For example, when the acquisition operation receiving information that has been acquired indicates that the acquisition operation of acquiring the coupon C5 has been received, the item management unit 122 requests the image output unit 124 to output an item acquisition complete image indicating that the coupon C5 has been acquired. Upon reception of the request, the image output unit 124 outputs, to the display device 200 via the server communication unit 110, the item acquisition complete image indicating that the coupon C5 has been acquired.

### (Step S8)

The image acquisition unit 224 of the display device 200 acquires the item acquisition complete image via the display device communication unit 210. The image acquisition unit 224 outputs the item acquisition complete image to the display control unit 225 and the display control unit 225 outputs an image signal indicating the item acquisition complete image to the display device display unit 240.

### (Step S9)

The display device display unit 240 displays the item acquisition complete image indicated by the image signal. For example, when the item acquisition complete image is an item presentation image that does not include the coupon C5, the display device display unit 240 displays, as the item acquisition complete image, an item presentation image that does not include the coupon C5 as illustrated in FIG. 7(b).

### (Step S10)

When the processing at step S7 ends, the item management unit 122 of the server 100 refers to the acquisition operation receiving information that has been acquired and acquires a target item from the item storage unit 130. The item management unit 122 requests the item output unit 123 to output the acquired target item. Upon reception of the request, the item output unit 123 outputs the target item to the display device 200 via the server communication unit 110.

### (Step S11)

The item acquisition unit 223 of the display device 200 acquires the target item via the display device communication unit 210. The item acquisition unit 223 then outputs the target item to the NFC control unit 221.

### (Step S12)

The NFC control unit 221 outputs the target item to the mobile terminal 300 via the NFC antenna 250 that performs NFC communication with the mobile terminal 300.

### (Step S13)

The item acquisition unit 324 of the mobile terminal 300 acquires the target item via the NFC-I/F unit 350.

### (Step S14)

The item acquisition unit 324 outputs the target item to the display control unit 321 and the display control unit 321 outputs an image signal indicating the target item to the mobile terminal display unit 340. The mobile terminal display unit 340 displays an image indicated by the image signal. For example, when the mobile terminal 300 acquires the coupon C5, the mobile terminal display unit 340 displays an image indicating the coupon C5 as illustrated in FIG. 7(b).

Note that, the server 100 may execute step S7 and step S10 described above by switching processing order thereof, and the similar also applies to other embodiments.

The target item may be set to the NFC antenna 250. In this case, the processing at step S10 and step S11 described above is not executed, and the NFC control unit 221 outputs the target item indicated by the acquisition operation received at step S4 to the mobile terminal 300 via the NFC antenna 250 at step S12.

As described above, in the item providing system 1 according to the present embodiment, the server 100 outputs an item presentation image to the display device 200 and acquires acquisition operation information from the display device 200. Then, the server 100 outputs an item acquisition complete image and the display device 200 displays the item acquisition complete image. For example, the server 100 outputs, as the item acquisition complete image, an item presentation image that does not include an acquired item. Thus, in the item providing system 1, an image displayed by the display device 200 is changed from an image that has been presented to the user to an image in which the item acquired by the user is not included, so that it is possible in the item providing system 1 to intuitively notify the user that the item has been acquired.

### (Processing 2 of Item Providing System 1)

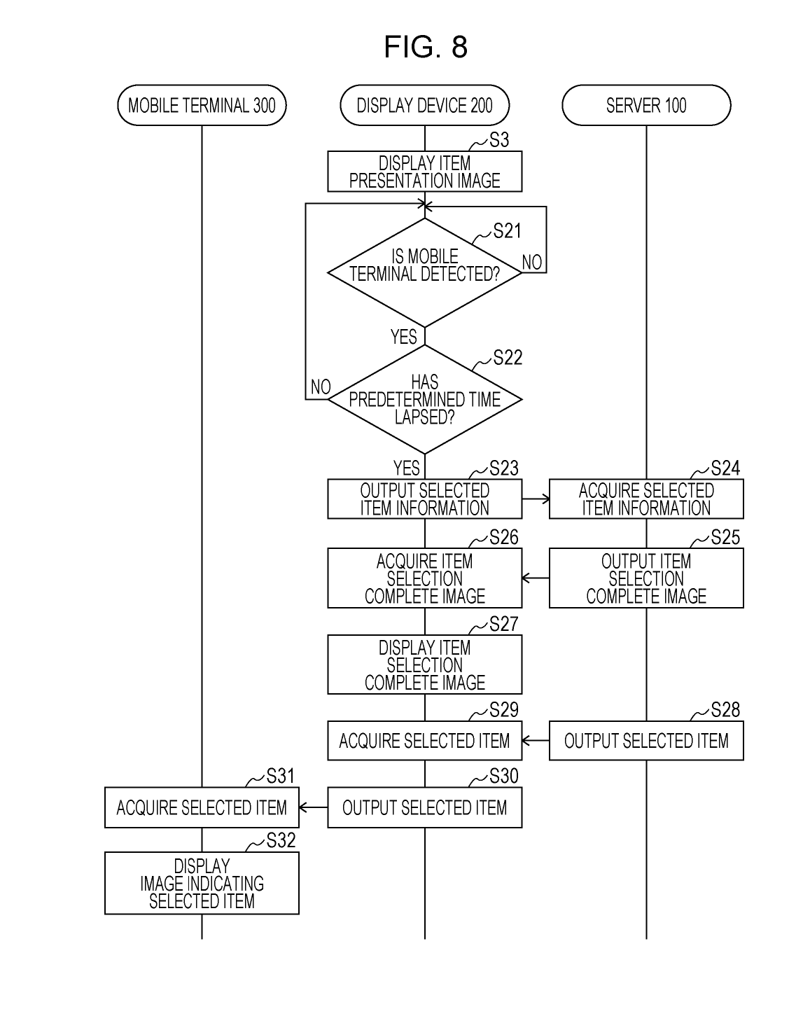

FIG. 8 is a sequence view illustrating a flow of item selection processing in the item providing system 1 according to Embodiment 1 of the invention. The item selection processing that is processing in which the mobile terminal 300 selects a target item in the item providing system 1 will be described with the use of FIG. 8.

Processing at step S1 to step S3 in which the server 100 outputs an item presentation image to the display device 200 and the display device 200 displays the item presentation image is the same as the processing described above, so that the description thereof will be omitted.

### (Step S21)

The NFC control unit 221 determines whether or not there is an NFC antenna 250 performing NFC communication with the mobile terminal 300. In other words, the NFC control unit 221 determines whether or not the mobile terminal 300 is detected.

When determining that “the mobile terminal 300 is not detected” at step S21 (step S21: NO), the NFC control unit 221 returns to the processing at step S21 to determine again whether or not the mobile terminal 300 is detected.

### (Step S22)

On the other hand, when determining that “the mobile terminal 300 is detected” at step S21 (step S21: YES), the NFC control unit 221 determines whether or not a predetermined time (for example, one second) has lapsed without change of the NFC antenna 250 performing NFC communication with the mobile terminal 300. For example, when the mobile terminal 300 and the NFC antenna 250(2,2) perform NFC communication, the NFC control unit 221 determines whether or not a predetermined time has lapsed without interruption of the communication between the mobile terminal 300 and the NFC antenna 250(2,2).

As another method, the NFC control unit 221 determines whether or not a predetermined time (for example, one second) has lapsed without change of the NFC antenna 250 outputting a detection signal. For example, when each of the NFC antenna 250(2,2), the NFC antenna 250(3,2), the NFC antenna 250(2,3), and the NFC antenna 250(3,3) outputs a detection signal, the NFC control unit 221 determines whether or not a detection signal has not been acquired for the predetermined time from NFC antennas 250 other than the NFC antenna 250(2,2), the NFC antenna 250(3,2), the NFC antenna 250(2,3), and the NFC antenna 250(3,3).

When determining that “the predetermined time has not lapsed” at step S22 (step S22: NO), the NFC control unit 221 returns to the processing at step S21 to determine again whether or not the mobile terminal 300 is detected.

### (Step S23)

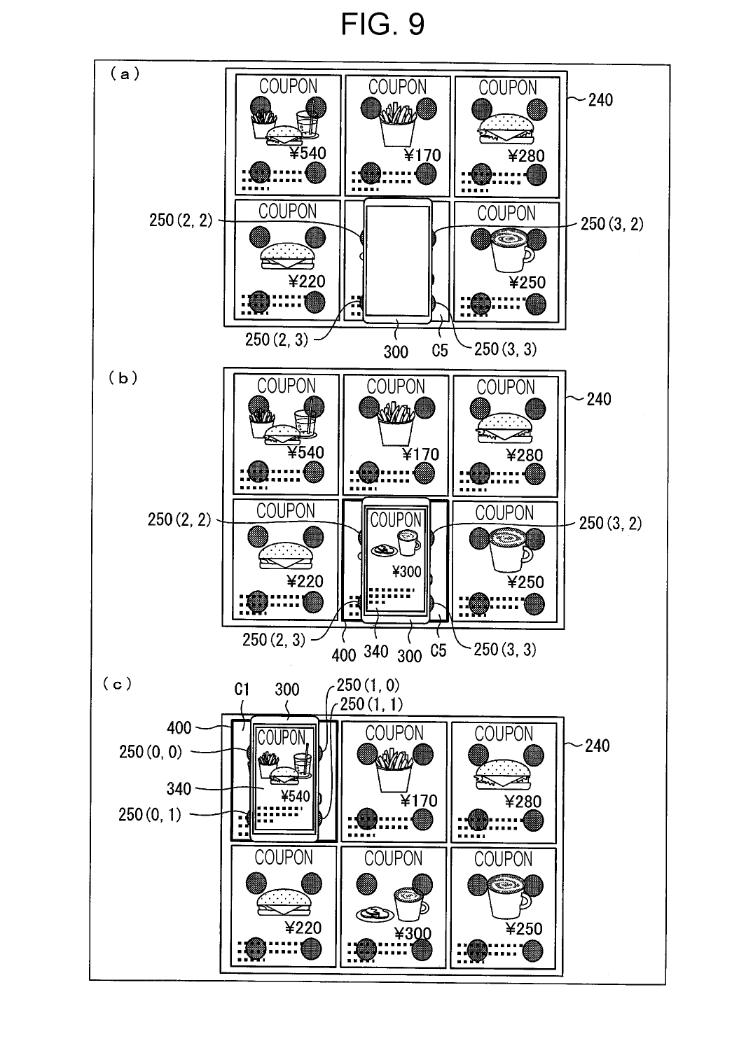

On the other hand, when determining that “the predetermined time has lapsed” at step S22 (step S22: YES), the NFC control unit 221 receives a selection operation that is an operation of selecting an item displayed in the region in which the NFC antenna 250 performing NFC communication with the mobile terminal 300 is arranged. Alternatively, the NFC control unit 221 receives a selection operation of selecting an item displayed in the region in which the NFC antenna 250 outputting a detection signal is arranged. Then, the NFC control unit 221 notifies the information output unit 222 that the selection operation has been received. Upon reception of the notification, the information output unit 222 outputs, to the server 100 via the display device communication unit 210, selected item information indicating that the selection operation has been received. An example of a method of receiving the selection operation by the NFC control unit 221 will be described with the use of FIG. 9. FIG. 9 illustrates an example of a selection operation in the item providing system 1 according to Embodiment 1 of the invention, in which (a) illustrates a state where the mobile terminal 300 is in proximity to the coupon C5, (b) illustrates a state where the coupon C5 is selected, and (c) illustrates a state where the coupon C1 is selected.

When the mobile terminal 300 is in proximity to the coupon C5 as illustrated in FIG. 9(a), the NFC control unit 221 detects that the NFC antenna 250(2,2) performs NFC communication with the mobile terminal 300. When the mobile terminal 300 and the NFC antenna 250(2,2) have performed communication for a predetermined time without interruption, the NFC control unit 221 receives the selection operation of selecting the coupon C5.

When the mobile terminal 300 is in proximity to the coupon C5 as illustrated in FIG. 9(a), the NFC control unit 221 acquires the detection signal output from each of the NFC antenna 250(2,2), the NFC antenna 250(3,2), the NFC antenna 250(2,3), and the NFC antenna 250(3,3). When the NFC control unit 221 has continuously acquired the detection signal from each of the NFC antenna 250(2,2), the NFC antenna 250(3,2), the NFC antenna 250(2,3), and the NFC antenna 250(3,3) for a predetermined time and has not acquired a detection signal from other NFC antennas 250, the NFC control unit 221 receives the selection operation of selecting the coupon C5.

### (Step S24)

The information acquisition unit 121 of the server 100 acquires, via the server communication unit 110, the selected item information output from the display device 200. The information acquisition unit 121 outputs the selected item information that has been acquired to the item management unit 122.

### (Step S25)

The item management unit 122 refers to the selected item information output from the information acquisition unit 121 and requests the image output unit 124 to output an item selection complete image indicating that an item indicated by the selected item information is selected. For example, when the selected item information that has been acquired indicates the selection operation of selecting the coupon C5, the item management unit 122 requests the image output unit 124 to output the items selection complete image indicating that the coupon C5 is selected. Upon reception of the request, the image output unit 124 outputs, to the display device 200 via the server communication unit 110, the item selection complete image indicating that the coupon C5 is selected.

### (Step S26)

The image acquisition unit 224 of the display device 200 acquires the item selection complete image via the display device communication unit 210. The image acquisition unit 224 outputs the item selection complete image to the display control unit 225 and the display control unit 225 outputs an image signal indicating the item selection complete image to the display device display unit 240.

### (Step S27)

The display device display unit 240 displays the item selection complete image indicated by the image signal. For example, when the item selection complete image is an item presentation image in which the coupon C5 is highlighted, an item presentation image in which the coupon C5 is highlighted by a highlight 400 as illustrated in FIG. 9(b) is displayed as the item selection complete image. For example, when a position of the mobile terminal 300 is changed and the item selection complete image is an item presentation image in which the coupon C1 is highlighted, an item presentation image in which the coupon C1 is highlighted as illustrated in FIG. 9(c) is displayed as the item selection complete image.

### (Step S28)

When the processing at step S25 ends, the item management unit 122 of the server 100 refers to the selected item information that has been acquired and acquires, from the item storage unit 130, the selected item that is selected. The item management unit 122 outputs the selected item that has been acquired to the item output unit 123. The item output unit 123 outputs the selected item that has been acquired to the display device 200 via the server communication unit 110.

### (Step S29)

The item acquisition unit 223 of the display device 200 acquires the selected item via the display device communication unit 210. The item acquisition unit 223 outputs the selected item to the NFC control unit 221.

### (Step S30)

The NFC control unit 221 outputs the selected item to the mobile terminal 300 via the NFC antenna 250 performing NFC communication with the mobile terminal 300.

### (Step S31)

The item acquisition unit 324 of the mobile terminal 300 acquires the selected item via the NFC-I/F unit 350.

### (Step S32)

The item acquisition unit 324 outputs the selected item to the display control unit 321 and the display control unit 321 outputs an image signal indicating the selected item to the mobile terminal display unit 340. The mobile terminal display unit 340 displays an image indicated by the image signal. For example, when the mobile terminal 300 selects the coupon C5, the mobile terminal display unit 340 displays an image indicating that the coupon C5 is selected as illustrated in FIG. 9(b). For example, when the mobile terminal 300 selects the coupon C1, the mobile terminal display unit 340 displays an image indicating that the coupon C1 is selected as illustrated in FIG. 9(c).

Note that, the server 100 may execute step S25 and step S28 described above by switching processing order thereof, and the similar also applies to other embodiments.

As described above, in the item providing system 1 according to the present embodiment, the server 100 acquires selected item information and outputs an item selection complete image to the display device 200. The display device 200 then displays the item selection complete image. For example, an item presentation image in which a selected item is highlighted is displayed as the item selection complete image in the item providing system 1. Thus, it is possible in the item providing system 1 to intuitively notify the user which item is selected.

Note that, although an item presentation image in which a selected item is highlighted is used as an example of an item selection complete image, the item selection complete image is not limited thereto, and, for example, an item presentation image in which brightness of items other than the selected item is reduced or an item presentation image in which a size of the selected item is increased may be used as the item selection complete image. The item selection complete image is desired to be an image by which the user is able to be notified of a change in display of the selected item even in a state where the selected item is not seen by the user because the mobile terminal 300 is in proximity to the display device 200 and the mobile terminal 300 is positioned on the selected item.

### (Processing 3 of Item Providing System 1)

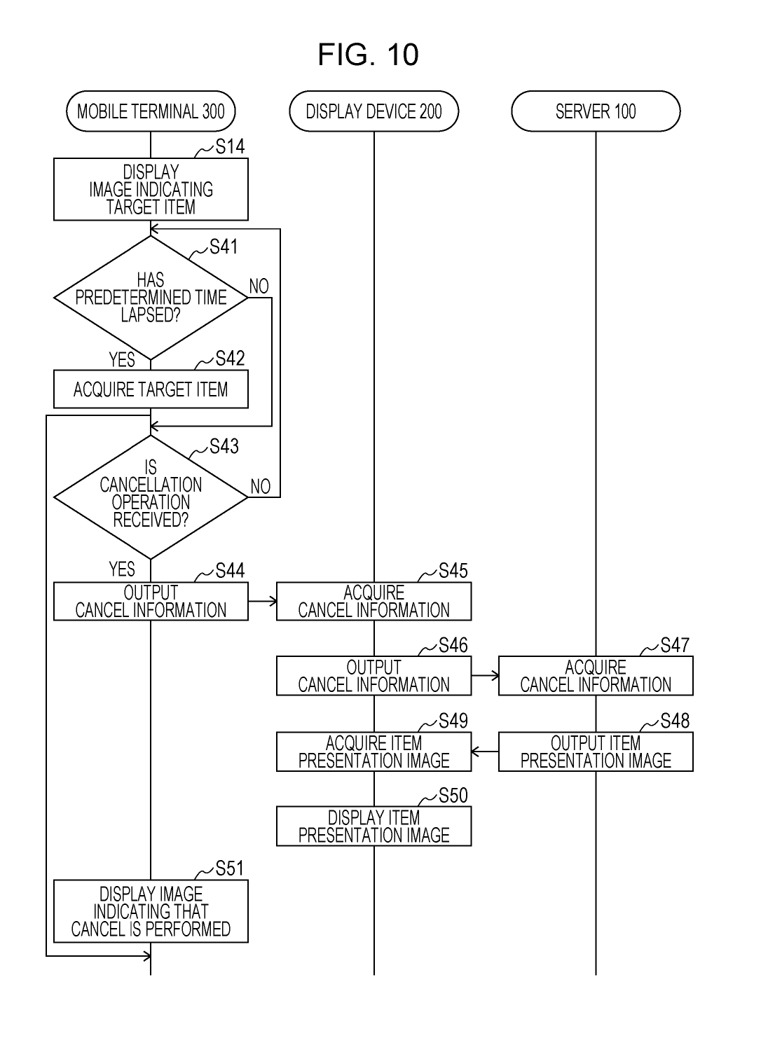

FIG. 10 is a sequence view illustrating a flow of item acquisition cancellation processing in the item providing system 1 according to Embodiment 1 of the invention. The item acquisition cancellation processing that is processing in which the mobile terminal 300 cancels acquisition of an item in the item providing system 1 will be described with the use of FIG. 10.

First, processing at step S1 to step S14 in which the server 100 outputs an item presentation image and the mobile terminal 300 displays an image indicating an acquired item in the item providing processing is the same as the processing described above, so that the description thereof will be omitted.

### (Step S41)

When the processing at step S14 ends, the item acquisition unit 324 of the mobile terminal 300 determines whether or not a predetermined time (for example, ten seconds or the like) has lapsed.

### (Step S42)

When determining that “the predetermined time has lapsed” at step S41 (step S41: YES), the item acquisition unit 324 acquires the target item acquired at step S13. Then, the processing indicated in FIG. 10 ends.

### (Step S43)

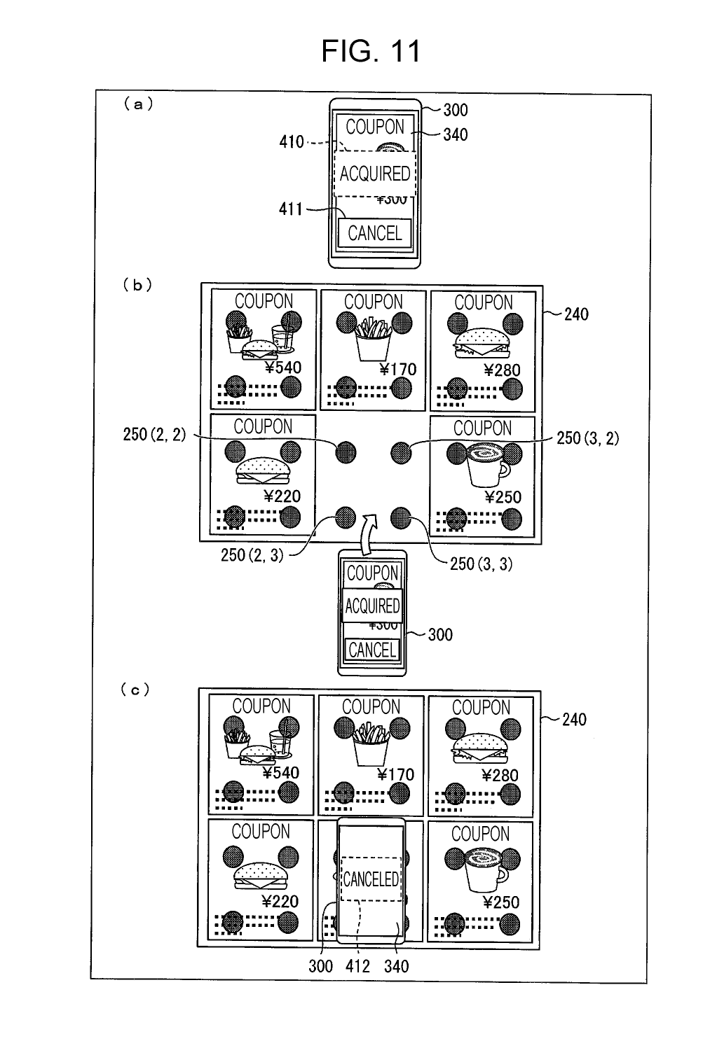

On the other hand, when determining that “the predetermined time has not lapsed” at step S41 (step S41: NO), the item acquisition unit 324 determines whether or not a cancellation operation is received from the user via the operation reception unit 360. The cancellation operation will be described with the use of FIG. 11. FIG. 11 illustrates an example of a cancellation operation in the item providing system 1 according to Embodiment 1 of the invention, in which (a) illustrates a state where an image indicating an item acquired by the mobile terminal 300 is displayed, (b) illustrates an operation of moving the mobile terminal 300 into proximity to the display device 200, and (c) illustrates the mobile terminal 300 and the display device 200 after the cancellation operation.

As illustrated in FIG. 11(a), a text 410 indicating that a coupon has been acquired and a cancel button 411 that receives an operation of canceling acquisition of the coupon are included in an image displayed on the mobile terminal display unit 340 by the mobile terminal 300 at step S14 described above. For example, when the operation signal acquisition unit 323 acquires an operation signal indicating that the cancel button 411 is pressed, the operation signal acquisition unit 323 outputs the acquired operation signal to the item acquisition unit 324. Upon acquisition of the operation signal, the item acquisition unit 324 determines that the cancellation operation is received.

As illustrated in FIG. 11(b), in a state where the coupon is displayed on the mobile terminal 300 and an item acquisition complete image is displayed on the display device display unit 240 of the display device 200, the mobile terminal 300 is made proximate to the region in which the acquired coupon has been displayed. Thereby, the item acquisition unit 324 is able to detect, via the NFC-I/F unit 350, that the mobile terminal 300 is in proximity to the display device 200. When detecting that the mobile terminal 300 is in proximity to the display device 200, the item acquisition unit 324 determines that the cancellation operation is received.

Note that, the display device 200 is desired to be configured not to receive, as the acquisition operation, an operation in which the mobile terminal 300 is displaced from the display device 200 next time after the cancellation operation is received. Such a configuration makes it possible to prevent the mobile terminal 300 from acquiring the canceled item again after the cancellation operation.

### (Step S44)

When determining that “the cancellation operation is received” at step S43 (step S44: YES), the item acquisition unit 324 outputs, via the NFC-I/F unit 350, cancel information indicating that the acquisition of the item is canceled.

### (Step S45)

The NFC control unit 221 of the display device 200 acquires the cancel information via the NFC antenna 250. The NFC control unit 221 outputs the cancel information to the information output unit 222.

Note that, when determining whether the cancel information is cancel information caused by pressing the cancel button 411 or cancel information caused by the mobile terminal 300 moving into proximity to the region in which the acquired coupon has been displayed, the NFC control unit 221 may perform the determination on the basis of a distance between the mobile terminal 300 and the display device 200. For example, the NFC control unit 221 may determine that cancel information acquired when communication intensity of NFC communication of the NFC antenna 250 is greater than a predetermined value (in other words, when the mobile terminal 300 and the display device 200 are closer to each other than a predetermined distance) is the cancel information caused by the mobile terminal 300 moving into proximity to the region in which the acquired coupon has been displayed. As another example, the NFC control unit 221 may determine that cancel information acquired when an average value of detection signals output from the respective NFC antennas 250 is greater than a predetermined value (in other words, when the mobile terminal 300 and the display device 200 are closer to each other than a predetermined distance) is the cancel information caused by the mobile terminal 300 moving into proximity to the region in which the acquired coupon has been displayed.

### (Step S46)

The information output unit 222 outputs the cancel information to the server 100 via the display device communication unit 210.

### (Step S47)

The information acquisition unit 121 of the server 100 acquires the cancel information via the server communication unit 110. The information acquisition unit 121 outputs the cancel information to the item management unit 122.

### (Step S48)

Upon acquisition of the cancel information, the item management unit 122 requests the image output unit 124 to output an item presentation image. Upon reception of the request, the image output unit 124 outputs the item presentation image to the display device 200 via the server communication unit 110.

### (Step S49)

Upon acquisition of the item presentation image via the display device communication unit 210, the image acquisition unit 224 of the display device 200 outputs the item presentation image to the display control unit 225.

### (Step S50)

The display control unit 225 acquires the item presentation image and outputs an image signal indicating the item presentation image to the display device display unit 240. Upon acquisition of the image signal output from the display control unit 225, the display device display unit 240 displays the item presentation image indicated by the image signal. For example, the display device display unit 240 displays the item presentation image as illustrated in FIG. 11(c).

### (Step S51)

After the processing at step S44 described above ends, the item acquisition unit 324 of the mobile terminal 300 requests the display control unit 321 to display an image indicating that the acquisition of the item is canceled. Upon reception of the request, the display control unit 321 outputs, to the mobile terminal display unit 340, an image signal that indicates the image indicating that the acquisition of the item is canceled. The mobile terminal display unit 340 displays the image indicated by the image signal. For example, an image that includes a text “canceled” 412 indicating that cancel is performed is displayed as illustrated in FIG. 11(c). Then, the processing indicated in FIG. 10 ends.

When determining that “the cancellation operation is not received” at step S43 described above (step S43: NO), the item acquisition unit 324 returns to the processing at step S41 to determine whether or not the predetermined time has lapsed.

As described above, in the item providing system 1 according to the present embodiment, the server 100 acquires cancel information and outputs an item presentation image to the display device 200. The display device 200 then displays the item presentation image. Thus, since an image to be presented to the user is changed from an item acquisition complete image to the item presentation image in the item providing system 1, it is possible to intuitively notify the user that the acquisition of the item is canceled.

Note that, when the mobile terminal 300 is configured to be able to output data via the mobile terminal communication unit 310 to at least one of the server 100 and the display device 200 as in configurations in Embodiment 2 and Embodiment 5 described later, the mobile terminal 300 may be configured to output cancel information to at least one of the server 100 and the display device 200.

When the mobile terminal 300 is configured to be able to output data to the server 100 via the mobile terminal communication unit 310 and, for example, the operation signal acquisition unit 323 of the mobile terminal 300 acquires an operation signal indicating that the cancel button 411 illustrated in FIG. 11(a) is pressed, the item acquisition unit 324 outputs cancel information to the server 100 via the mobile terminal communication unit 310 at step S44 described above. Then, the information acquisition unit 121 of the server 100 acquires the cancel information via the server communication unit 110 at step S47.

When the mobile terminal 300 is configured to be able to output data to the display device 200 via the mobile terminal communication unit 310 and, for example, the operation signal acquisition unit 323 of the mobile terminal 300 acquires an operation signal indicating that the cancel button 411 illustrated in FIG. 11(a) is pressed, the item acquisition unit 324 outputs cancel information to the display device 200 via the mobile terminal communication unit 310 at step S44 described above. Then, the information acquisition unit of the display device 200 acquires the cancel information via the display device communication unit 210 at step S45.

As described above, when the mobile terminal 300 is configured to be able to output data via the mobile terminal communication unit 310 to at least one of the server 100 and the display device 200, the mobile terminal 300 is able to execute item acquisition cancellation processing by outputting cancel information not via the NFC-I/F unit 350 but via the mobile terminal communication unit 310.

### Embodiment 2

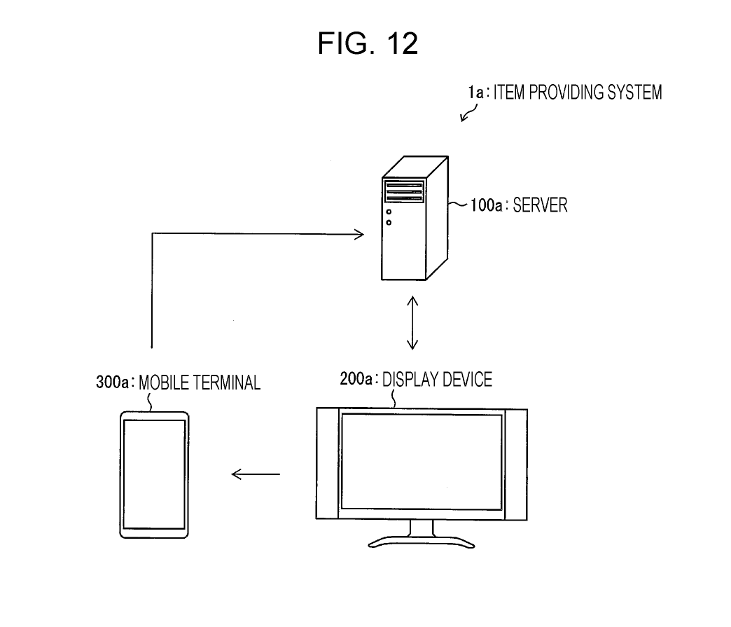

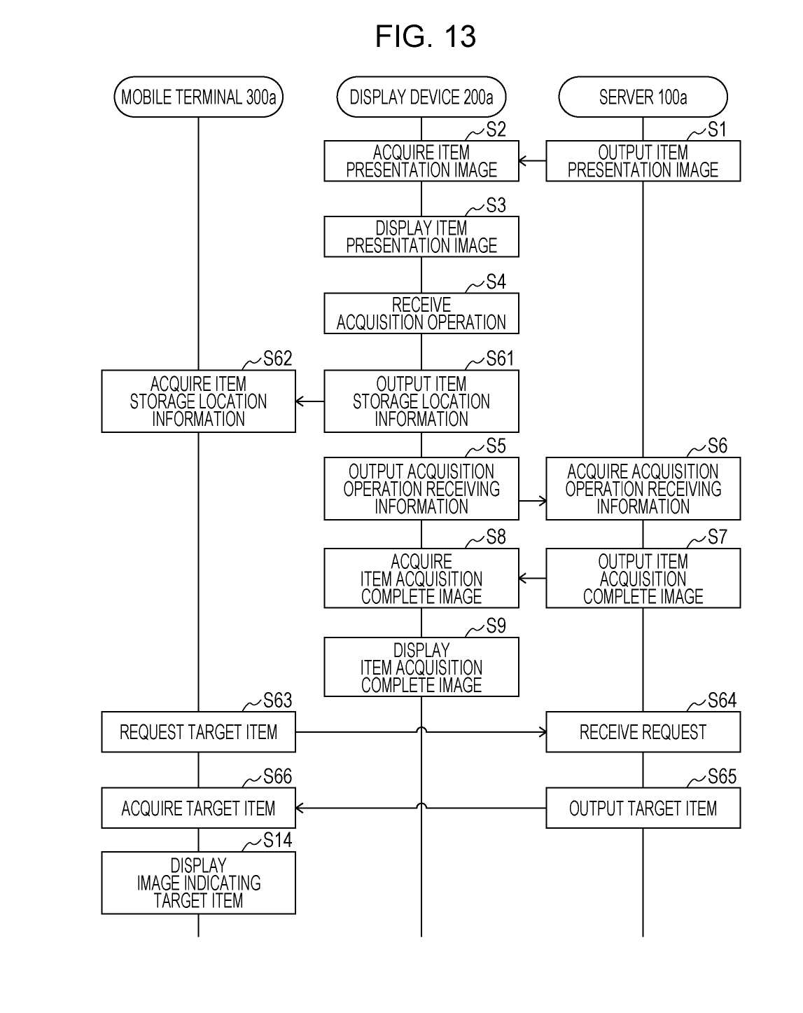

Another embodiment of the invention will be described as follows with reference to FIGS. 12 and 13. Note that, for convenience of description, the same reference signs are assigned to members having the same functions as those of members described in the aforementioned embodiment, and the description thereof will be omitted.

### (Item Providing System 1a)

FIG. 12 schematically illustrates an item providing system 1a according to Embodiment 2 of the invention. The item providing system 1a includes a server 100a, a display device 200a, and a mobile terminal 300a as illustrated in FIG. 12. In the item providing system 1a, the mobile terminal 300a acquires, as a right to acquire a target item, item storage location information indicating a storage location at which the target item is stored. In the present embodiment, item storage location information indicating a storage location of an item displayed in a region in which each of the NFC antennas 250 is arranged is set to each of the NFC antennas 250 of the display device 200. Moreover, in the present embodiment, since an item is stored in the item storage unit 130, the storage location indicated by the item storage location information is an address of the item storage unit 130.

Note that, configurations of the server 100a, the display device 200a, and the mobile terminal 300a are respectively the same as the aforementioned configurations of the server 100, the display device 200, and the mobile terminal 300, so that the description thereof will be omitted.

### (Processing of Item Providing System 1a)

FIG. 13 is a sequence view illustrating a flow of item acquisition right providing processing in the item providing system 1a according to Embodiment 2 of the invention. With the use of FIG. 13, the item acquisition right providing processing that is processing up to display of an image indicating a right to acquire an item acquired by the mobile terminal 300 in the item providing system 1a will be described.

First, processing at step S1 to step S4 in which the server 100a outputs an item presentation image and the display device 200a receives an acquisition operation is the same as the processing at step S1 to step S4 described above, so that the description thereof will be omitted.

### (Step S61)

The NFC control unit 221 outputs, to the mobile terminal 300d via the NFC antenna 250 that has received the acquisition operation at step S4, item storage location information that is set to the NFC antenna 250. For example, when the NFC antenna 250(0,0) performs NFC communication with the mobile terminal 300a while the display device 200a displays the item presentation image illustrated in FIG. 6, the NFC control unit 221 outputs, to the mobile terminal 300a via the NFC antenna 250(0,0), item storage location information (item storage location information indicating a storage location of the coupon C1) that is set to the NFC antenna 250(0,0).

### (Step S62)

The item acquisition unit 324 of the mobile terminal 300a acquires the item storage location information via the NFC-I/F unit 350.

Subsequently, processing at step S5 to step S9 in which the display device 200a outputs acquisition operation receiving information and displays an item acquisition complete image is the same as the processing at step S5 to step S9 described above, so that the description thereof will be omitted.

### (Step S63)

When the processing at step S62 ends, the item acquisition unit 324 of the mobile terminal 300a requests a target item via the mobile terminal communication unit 310 to the server 100a that is a storage location indicated by the acquired item storage location information.

### (Step S64)

The information acquisition unit 121 of the server 100a receives the request of the mobile terminal 300a via the server communication unit 110 and, in accordance with the request, requests the item management unit 122 to acquire the target item stored in the storage location.

### (Step S65)

Upon reception of the request, the item management unit 122 acquires the target item stored in the storage location from the item storage unit 130. The item management unit 122 then outputs the acquired target item to the item output unit 123. The item output unit 123 outputs the acquired target item to the mobile terminal 300a via the server communication unit 110.

### (Step S66)

The item acquisition unit 324 of the mobile terminal 300a acquires, via the mobile terminal communication unit 310, the target item output from the server 100a. Processing in which the mobile terminal display unit 340 displays an image indicating the target item is the same as that of step S14 described above, so that the description thereof will be omitted.

As described above, item storage location information is output from the display device 200a to the mobile terminal 300a in the item providing system 1a according to the present embodiment. The mobile terminal 300a then requests an item to a storage location indicated by the item storage location information. Thus, since the display device 200a does not acquire or output a target item in the item providing system 1a, it is possible to reduce processing of the display device 200a.

### Embodiment 3

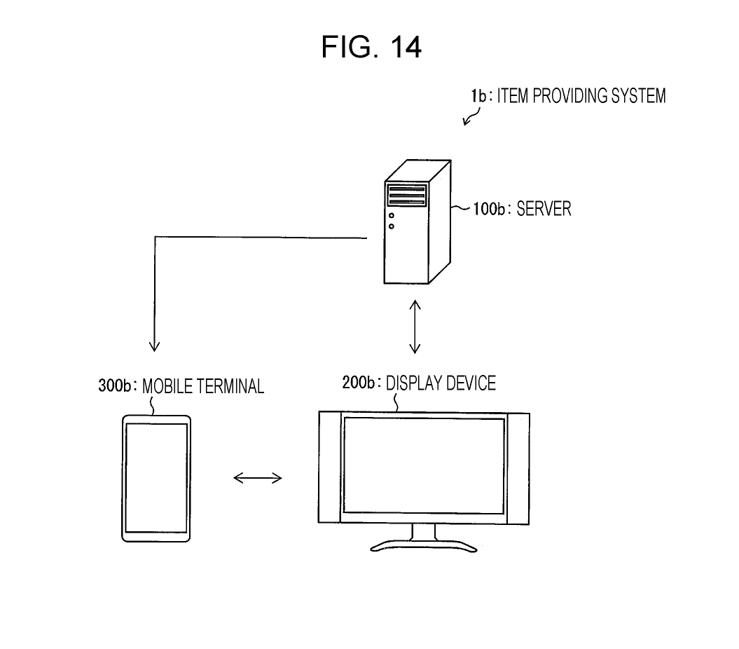

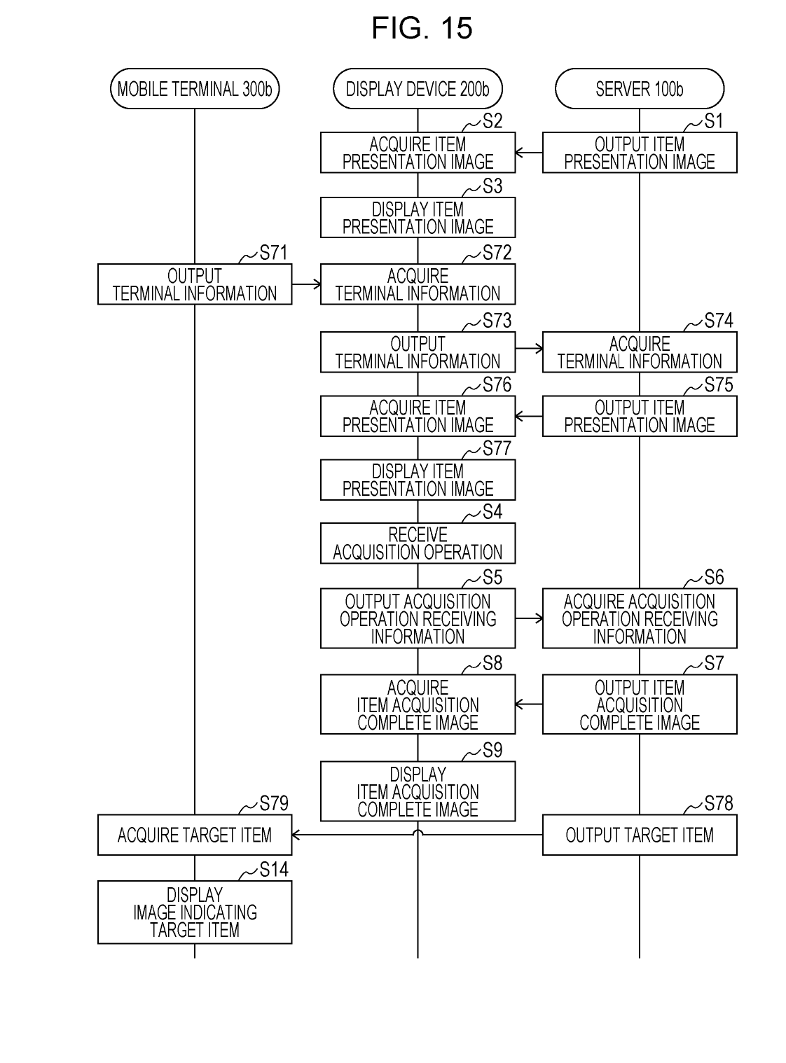

Another embodiment of the invention will be described as follows with reference to FIGS. 14 and 15. Note that, for convenience of description, the same reference signs are assigned to members having the same functions as those of members described in the aforementioned embodiments, and the description thereof will be omitted.

### (Item Providing System 1b)

FIG. 14 schematically illustrates an item providing system 1b according to Embodiment 3 of the invention. The item providing system 1b includes a server 100b, a display device 200b, and a mobile terminal 300b as illustrated in FIG. 14. In the item providing system 1b, the display device 200b acquires mobile terminal information that is information related to the mobile terminal 300b and displays an item presentation image associated with the mobile terminal information. Note that, configurations of the server 100b, the display device 200b, and the mobile terminal 300b are respectively the same as the aforementioned configurations of the server 100, the display device 200, and the mobile terminal 300 described above, so that the description thereof will be omitted. Note that, it is configured so that the mobile terminal information includes at least a notification destination of the mobile terminal 300b in the present embodiment.

### (Processing of Item Providing System 1b)

FIG. 15 is a sequence view illustrating a flow of item providing processing in the item providing system 1b according to Embodiment 3 of the invention. The item providing processing in the item providing system 1b will be described with the use of FIG. 15.

First, processing at step S1 to step S3 in which the server 100a outputs an item presentation image and the display device 200b displays the item presentation image is the same as the processing at step S1 to step S3 described above, so that the description thereof will be omitted.

### (Step S71)

When the mobile terminal 300b is in proximity to the display device 200b and thereby performs NFC communication with the display device 200b, the NFC control unit 325 of the mobile terminal 300b requests the terminal information management unit 326 to output mobile terminal information. Upon reception of the request, the terminal information management unit 326 outputs the mobile terminal information via the NFC-I/F unit 350.

### (Step S72)

The NFC control unit 221 of the display device 200 acquires the mobile terminal information via the NFC antenna 250. The NFC control unit 221 then outputs the mobile terminal information to the information output unit 222.

### (Step S73)

Upon acquisition of the mobile terminal information, the information output unit 222 outputs the mobile terminal information to the server 100b via the display device communication unit 210.

### (Step S74)

The information acquisition unit 121 of the server 100 acquires the mobile terminal information via the server communication unit 110. The information acquisition unit 121 then outputs the mobile terminal information to the item management unit 122.

### (Step S75)

Upon acquisition of the mobile terminal information, the item management unit 122 requests the image output unit 124 to output an item presentation image associated with the mobile terminal information. Upon reception of the request, the image output unit 124 outputs the item presentation image associated with the mobile terminal information to the display device 200b via the server communication unit 110. For example, when an age of the user is included in the mobile terminal information, an item presentation image associated with the age of the user is output to the display device 200b.

### (Step S76)

Upon acquisition of the item presentation image via the display device communication unit 210, the image acquisition unit 224 of the display device 200b outputs the item presentation image to the display control unit 225.

### (Step S77)

The display control unit 225 acquires the item presentation image and outputs an image signal indicating the item presentation image to the display device display unit 240. Upon acquisition of the image signal output from the display control unit 225, the display device display unit 240 displays the item presentation image indicated by the image signal.

Subsequently, processing at step S4 to step S9 in which the display device 200b receives an acquisition operation and the display device 200b displays an item acquisition complete image is the same as the processing described above, so that the description thereof will be omitted.

### (Step S78)

When the processing of step S7 ends, the item management unit 122 of the server 100b refers to acquisition operation receiving information that has been acquired and acquires a target item from the item storage unit 130. Then, the item management unit 122 requests the item output unit 123 to output the acquired target item to a notification destination indicated by the acquired mobile terminal information. Upon reception of the request, the item output unit 123 outputs the acquired target item to the notification destination indicated by the mobile terminal information.

### (Step S79)

The item acquisition unit 324 of the mobile terminal 300b acquires, via the mobile terminal communication unit 310, the target item output from the server 100b. Processing in which the mobile terminal display unit 340 displays an image indicating the target item is the same as that of step S14 described above, so that the description thereof will be omitted.

As described above, in the item providing system 1b according to the present embodiment, the server 100b acquires mobile terminal information of the mobile terminal that acquires an item and outputs an item presentation image associated with the mobile terminal information to the display device 200b. For example, when an age of the user is included in the mobile terminal information, an item presentation image according to the age of the user is able to be output, so that it is possible to present an item presentation image according to the user in the item providing system 1b. In a case where a notification destination is included in the mobile terminal information, the server 100b is able to output a target item to the mobile terminal 300b, and hence, even when the mobile terminal 300b and the display device 200b are away from each other, the target item is able to be output to the mobile terminal 300b in the item providing system 1b. Note that, in a case where the notification destination is not included in the mobile terminal information, the processing at step S10 to step S13 described above may be executed.

### Embodiment 4

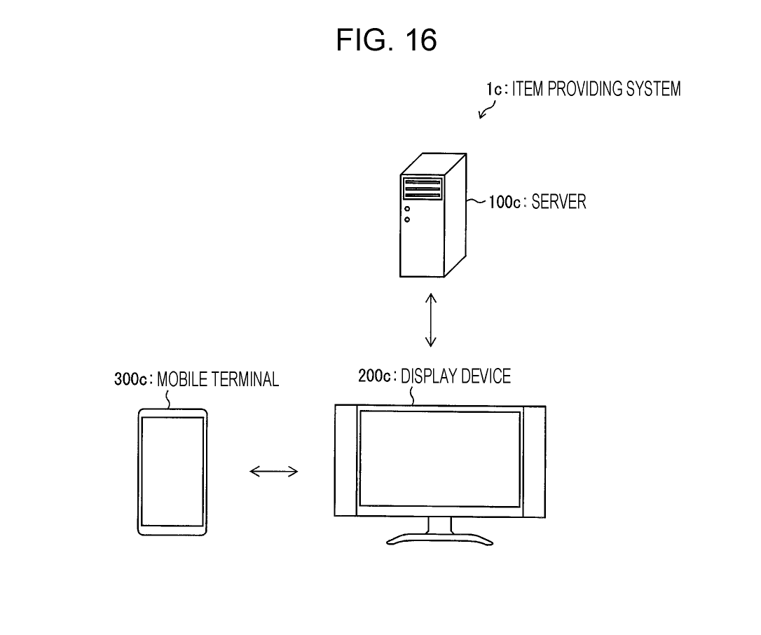

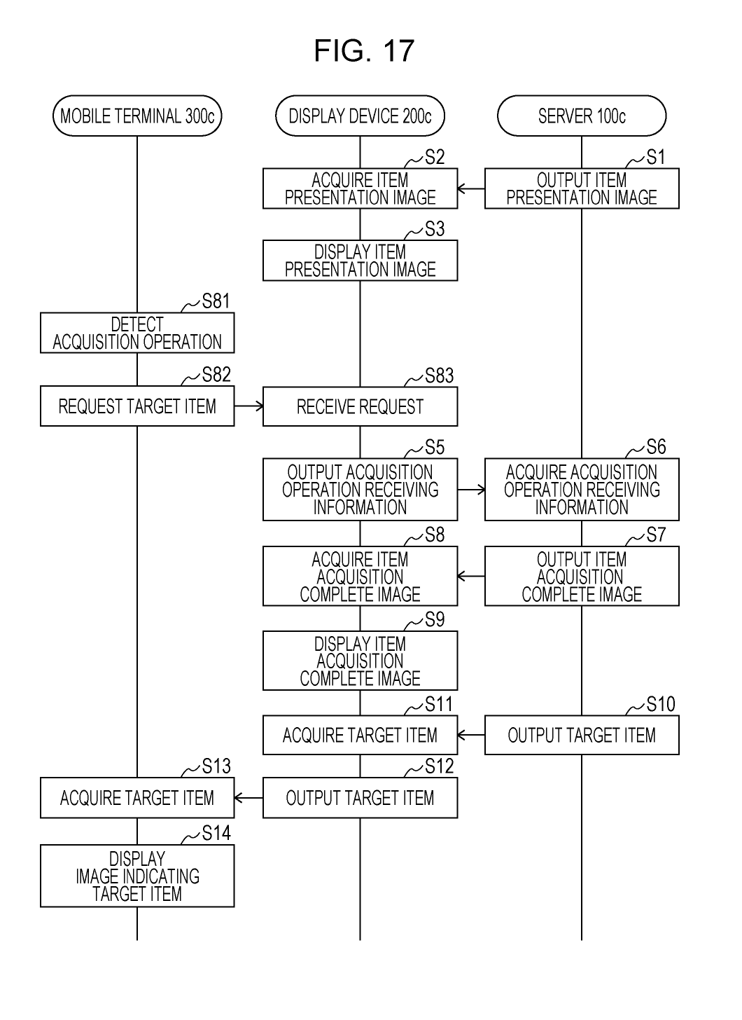

Another embodiment of the invention will be described as follows with reference to FIGS. 16 and 17. Note that, for convenience of description, the same reference signs are assigned to members having the same functions as those of members described in the aforementioned embodiments, and the description thereof will be omitted.

### (Item Providing System 1c)

FIG. 16 schematically illustrates an item providing system 1c according to Embodiment 4 of the invention. The item providing system 1c includes a server 100c, a display device 200c, and a mobile terminal 300c as illustrated in FIG. 16. In the item providing system 1c, the mobile terminal 300c detects an acquisition operation and requests a target item.

### (Processing of Item Providing System 1c)

FIG. 17 is a sequence view illustrating a flow of item providing processing in the item providing system 1c according to Embodiment 4 of the invention. The item providing processing in the item providing system 1c will be described with the use of FIG. 17.

First, processing at step S1 to step S3 in which the server 100a outputs an item presentation image and the display device 200b displays the item presentation image is the same as the processing at step S1 to step S3 described above, so that the description thereof will be omitted.

### (Step S81)

The NFC control unit 325 of the mobile terminal 300 detects an acquisition operation. The NFC control unit 325 then notifies the item acquisition unit 324 that the acquisition operation has been detected. A method of detecting the acquisition operation by the NFC control unit 325 will be described here. The NFC control unit 325 detects that NFC communication is performed and determines whether or not communication intensity of the NFC communication becomes smaller than a predetermined value. When determining that the communication intensity of the NFC communication becomes smaller than the predetermined value, the NFC control unit 325 detects the acquisition operation.

As another method, the NFC control unit 325 acquires a detection signal indicating that a plurality of NFC antennas 250 are in proximity and a distance from each of the plurality of NFC antennas 250. The NFC control unit 325 then determines whether or not a value of the detection signal becomes smaller than a predetermined value, and when determining that the value of the detection signal becomes smaller than the predetermined value, the NFC control unit 325 detects the operation as the acquisition operation.

For example, when the mobile terminal 300c is at the position of the mobile terminal 300 illustrated in FIG. 9(b), the NFC control unit 325 acquires a detection signal indicating that the NFC antenna 250(2,2), the NFC antenna 250(2,3), the NFC antenna 250(3,2), and the NFC antenna 250(3,3) are in proximity and a distance from each of the NFC antenna 250(2,2), the NFC antenna 250(2,3), the NFC antenna 250(3,2), and the NFC antenna 250(3,3). When the mobile terminal 300c is moved to the position of the mobile terminal 300 illustrated in FIG. 9(c), the NFC control unit 325 acquires a detection signal indicating a distance from each of the NFC antenna 250(0,0), the NFC antenna 250(0,1), the NFC antenna 250(1,0), and the NFC antenna 250(1,1). Thus, even when the mobile terminal 300c is moved from the position of the mobile terminal 300 illustrated in FIG. 9(b) to the position of the mobile terminal 300 illustrated in FIG. 9(c), the value of the detection signal acquired by the NFC control unit 325 is not reduced, so that the NFC control unit 325 does not detect the operation as the acquisition operation.

On the other hand, when the mobile terminal 300c is moved from the position of the mobile terminal 300 illustrated in FIG. 9(b) to the position of the mobile terminal 300 illustrated in FIG. 7(b), the value of the detection signal acquired by the NFC control unit 325 is reduced, so that the NFC control unit 325 detects the operation as the acquisition operation.

### (Step S82)

Upon reception of the notification from the NFC control unit 325, the item acquisition unit 324 requests a target item to the display device 200c via the NFC-I/F unit 350.

### (Step S83)

The NFC control unit 221 of the display device 200c receives, via the NFC antenna 250, the request from the mobile terminal 300c. Processing subsequent to step S5 in which the NFC control unit 221 receives the request and outputs acquisition operation receiving information is the same as the processing in the aforementioned embodiment, so that the description thereof will be omitted.

As described above, in the item providing system 1c according to the present embodiment, the mobile terminal 300c detects an acquisition operation and requests a target item to the display device 200c. Thus, since the display device 200c does not detect an acquisition operation in the item providing system 1c, it is possible to reduce processing of the display device 200c.

### Embodiment 5

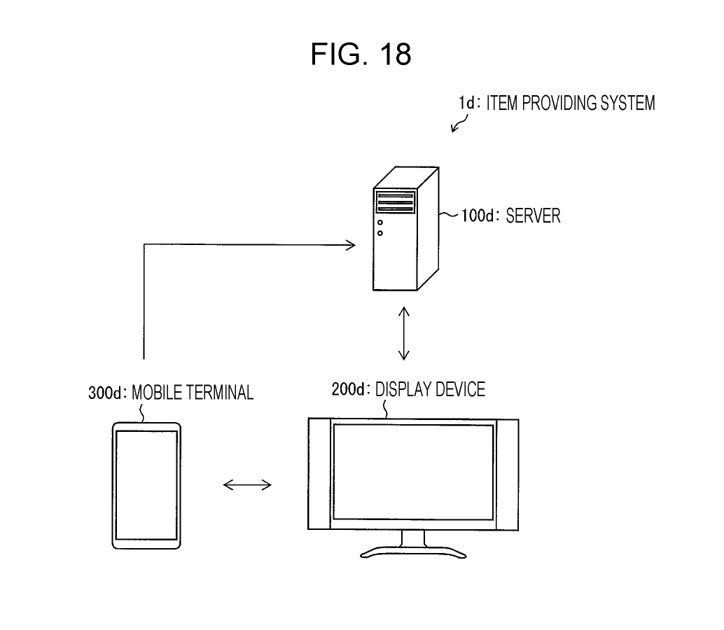

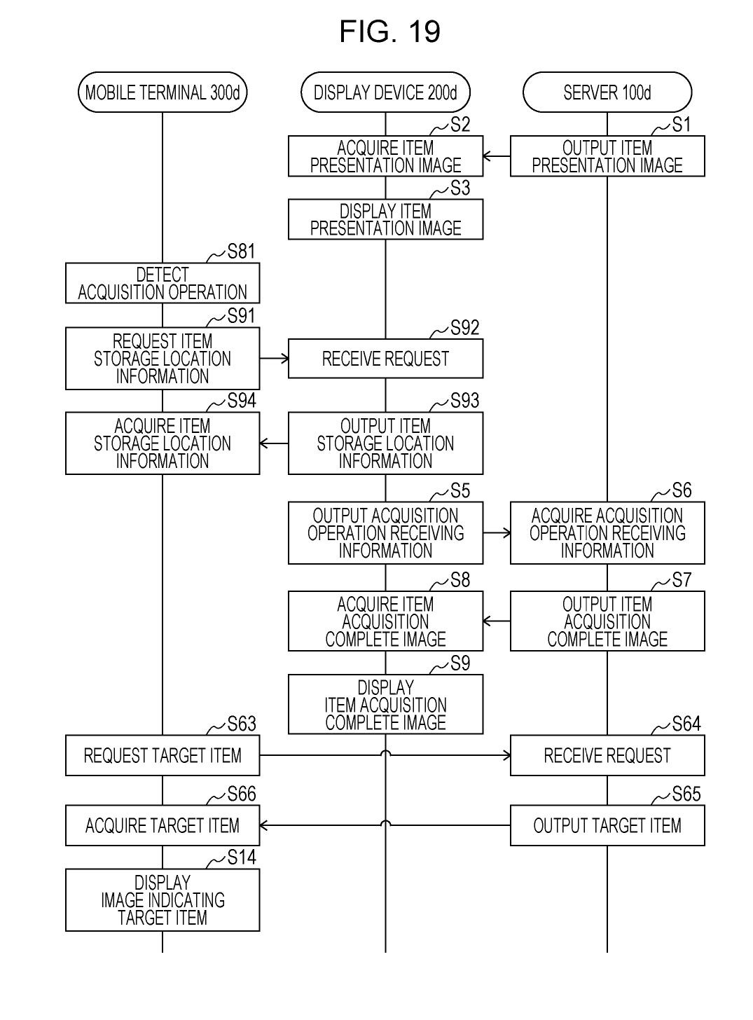

Another embodiment of the invention will be described as follows with reference to FIGS. 18 and 19. Note that, for convenience of description, the same reference signs are assigned to members having the same functions as those of members described in the aforementioned embodiments, and the description thereof will be omitted.

### (Item Providing System 1d)

FIG. 18 schematically illustrates an item providing system 1d according to Embodiment 5 of the invention. The item providing system 1d includes a server 100d, a display device 200d, and a mobile terminal 300d as illustrated in FIG. 18. In the item providing system 1d, the mobile terminal 300d detects an acquisition operation and acquires storage location information.

### (Processing of Item Providing System 1d)

FIG. 19 is a sequence view illustrating a flow of item providing processing in the item providing system 1d according to Embodiment 5 of the invention. The item providing processing in the item providing system 1d will be described with the use of FIG. 19.

First, processing at step S1 to step S3 in which the server 100d outputs an item presentation image and the display device 200d displays the item presentation image and processing at step S81 in which the mobile terminal 300d detects an acquisition operation are respectively the same as the processing at step S1 to step S3 and the processing at step S81 described above, so that the description thereof will be omitted.

### (Step S91)

Upon reception of, from the NFC control unit 325, notification indicating that an acquisition operation has been detected, the item acquisition unit 324 of the mobile terminal 300d requests a target item to the display device 200c via the NFC-I/F unit 350.

### (Step S92)

The NFC control unit 221 of the display device 200d receives the request via the NFC antenna 250.

### (Step S93)

Subsequently, upon reception of the request, the NFC control unit 221 outputs, to the mobile terminal 300d, item storage location information that is set to the NFC antenna 250.

### (Step S94)

The item acquisition unit 324 of the mobile terminal 300d acquires the item storage location information via the NFC-I/F unit 350. Processing subsequent to step S5 in which acquisition operation receiving information is output is the same as the processing in the aforementioned embodiment, so that the description thereof will be omitted.

As described above, in the item providing system 1d according to the present embodiment, the mobile terminal 300d detects an acquisition operation and requests item storage location information to the display device 200d. Thus, since the display device 200d does not detect an acquisition operation or does not acquire or output a target item in the item providing system 1d, it is possible to reduce processing of the display device 200d.

Note that, the item acquisition unit 324 of the mobile terminal 300d requests the item storage location information to the display device 200d at step S91, but the item acquisition unit 324 is not limited to such a configuration and may be configured to request at least one of a target item and a right to acquire the target item. When acquiring the target item, the item acquisition unit 324 may execute processing subsequent to step S13 described above. On the other hand, when acquiring the right to acquire the target item, the item acquisition unit 324 may execute processing subsequent to step S94.

### Embodiment 6

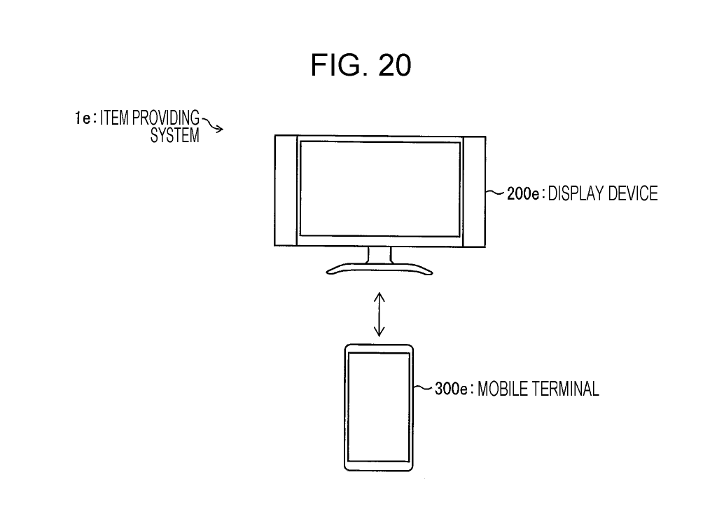

Another embodiment of the invention will be described as follows with reference to FIGS. 20 to 22. Note that, for convenience of description, the same reference signs are assigned to members having the same functions as those of members described in the aforementioned embodiments, and the description thereof will be omitted.

### (Item Providing System 1e)

FIG. 20 schematically illustrates an item providing system 1e according to Embodiment 6 of the invention. The item providing system 1e includes a display device 200e and a mobile terminal 300e as illustrated in FIG. 20. In the item providing system 1e, the display device 200e has the function of each of the servers 100 to 100d described above.

### (Display Device 200e)

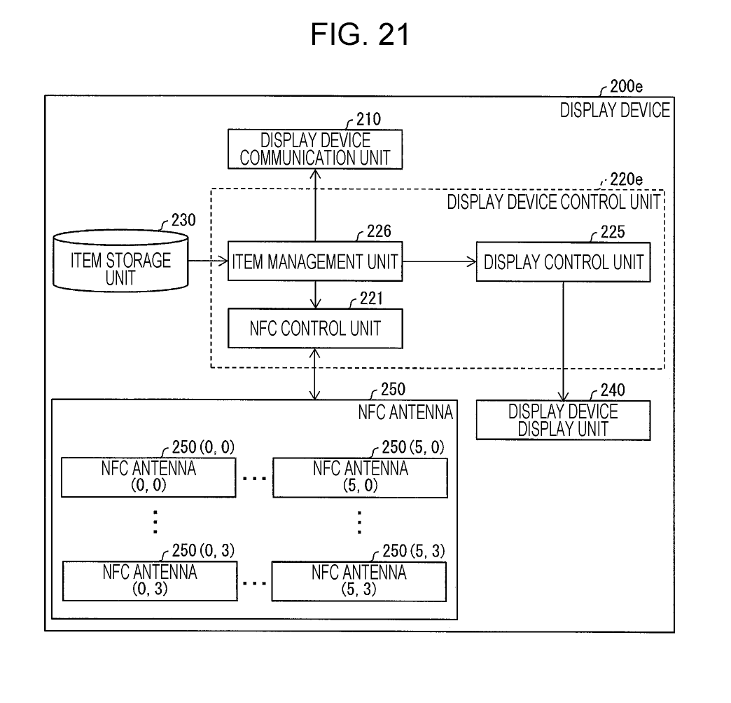

FIG. 21 is a block diagram illustrating a configuration of a main part of the display device 200e according to Embodiment 6 of the invention. The display device 200e will be described with the use of FIG. 21.

The display device 200e includes the display device communication unit 210, a display device control unit 220e, the item storage unit 230, the display device display unit 240, and the NFC antenna 250 as illustrated in FIG. 21. Note that, the display device communication unit 210, the display device display unit 240, and the NFC antenna 250 are respectively the same as the display device communication unit 210, the display device display unit 240, and the NFC antenna 250 in the aforementioned embodiments, so that the description thereof will be omitted.

In the item storage unit 230, one or more items are stored.

The display device control unit 220e integrally controls the components of the display device 200e. The display device control unit 220e will be described in detail below.

### (Display Device Control Unit 220e)

The display device control unit 220e functions also as the NFC control unit 221, the display control unit 225, and an item management unit 226 as illustrated in FIG. 21. Note that, the NFC control unit 221 and the display control unit 225 respectively have the same functions as those of the NFC control unit 221 and the display control unit 225 described above, so that the description thereof will be omitted.

Similarly to the item management unit 122 described above, the item management unit 226 manages an item stored in the item storage unit 230.

### (Processing of Item Providing System Le)

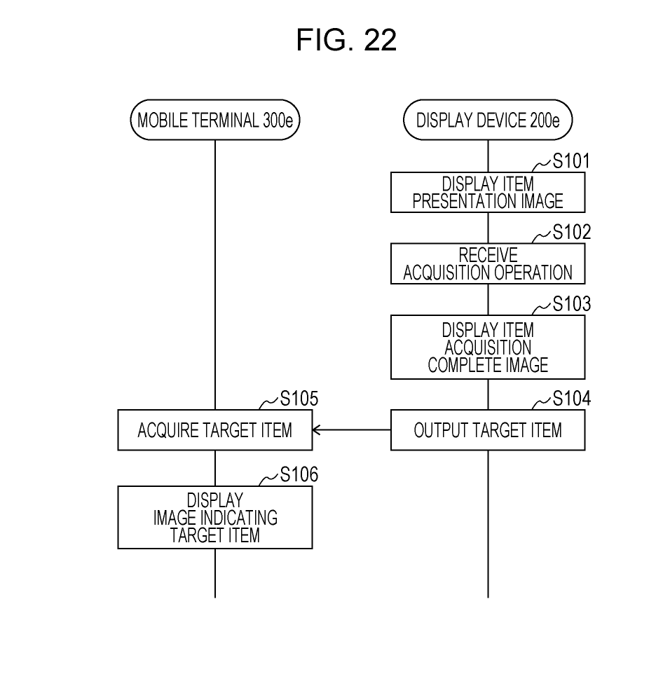

FIG. 22 is a sequence view illustrating a flow of item providing processing in the item providing system 1e according to Embodiment 6 of the invention. The item providing processing in the item providing system 1e will be described with the use of FIG. 22.

### (Step S101)

The item management unit 226 of the display device 200e requests the display control unit 225 to output an item presentation image. Upon reception of the request, the display control unit 225 outputs an image signal indicating the item presentation image to the display device display unit 240. Upon acquisition of the image signal, the display device display unit 240 displays the item presentation image.

### (Step S102)

The NFC control unit 221 receives an acquisition operation. The acquisition operation is received in the same manner as step S4 described above, so that the description thereof will be omitted. The NFC control unit 221 outputs acquisition operation receiving information indicating that the acquisition operation has been received to the item management unit 226.

### (Step S103)

The item management unit 226 refers to the acquisition operation receiving information that has been acquired and requests the display control unit 225 to output an item acquisition complete image. Upon reception of the request, the display control unit 225 displays the item acquisition complete image.

### (Step S104)

When the processing at step S103 ends, the item management unit 226 refers to the acquisition operation receiving information that has been acquired and acquires a target item from the item storage unit 230. The item management unit 226 then requests the NFC control unit 221 to output the acquired target item. Upon reception of the request, the NFC control unit 221 outputs the target item via the NFC antenna 250.

### (Step S105)

The item acquisition unit 324 of the mobile terminal 300e acquires the target item via the NFC-I/F unit 350.

### (Step S106)

The item acquisition unit 324 outputs the target item to the display control unit 321 and the display control unit 321 outputs an image signal indicating the acquired target item to the mobile terminal display unit 340. The mobile terminal display unit 340 displays an image indicated by the acquired image signal.

As described above, in the item providing system 1e according to the present embodiment, the display device 200e displays an item presentation image, receives an acquisition operation, and displays an item acquisition complete image. Thus, in the item providing system 1e, even when each of the servers 100 to 100d in the aforementioned embodiments is not included, it is possible to intuitively notify the user that the user has acquired an item or a right to acquire the item.

### Embodiment 7

A control block (in particular, the server control unit 120, the display device control unit 220, the display device control unit 220, and the mobile terminal control unit 320) of the servers 100 to 100d, the display devices 200 to 200e, and the mobile terminals 300 to 300e may be realized through a logical circuit (hardware) formed by an integrated circuit (IC chip) or the like or may be realized through software using a CPU (Central Processing Unit).

In the latter case, the servers 100 to 100d, the display devices 200 to 200e, and the mobile terminals 300 to 300e include a CPU that executes commands of a program serving as software that realizes the respective functions, a ROM (Read Only Memory) or a storage device (each of which is referred to as a “recording medium”) in which the program and various data are recorded to be readable by a computer (or the CPU), a RAM (Random Access Memory) that loads the program, and the like. The object of the invention is achieved by the computer (or the CPU) reading out and executing the program from the recording medium. It is possible to use a “non-transitory tangible medium”, for example, such as a tape, a disk, a card, a semiconductor memory, or a programmable logic circuit, as the recording medium. The program may be supplied to the computer via any transfer medium (such as a communication network or a broadcast wave) capable of transferring the program. Note that, the invention can be realized also in a form of a data signal in which the program is realized by electronic transfer and embedded in a carrier wave.

### Embodiment 8

Although an example in which one of the servers 100 to 100d is used has been described in each of the aforementioned embodiments, the respective functions of the servers 100 to 100d may be realized by individual servers. When a plurality of servers are applied, each of the servers may be managed by the same operator or may be managed by different operators.

### CONCLUSION

A server (100 to 100d) according to an aspect 1 of the invention includes: an image output unit (124) that outputs, to a display device, an item presentation image indicating one or more items; and an acquisition unit (information acquisition unit 121) that acquires acquisition operation receiving information indicating that the display device has received an acquisition operation that is an operation of acquiring at least one of a target item of the one or more items and a right to acquire the target item, in which when the acquisition unit acquires the acquisition operation receiving information, the image output unit outputs an item acquisition complete image indicating that at least one of the target item and the right to acquire the target item has been acquired.

According to the aforementioned configuration, the server outputs, to the display device, the item presentation image indicating one or more items and acquires the acquisition operation information indicating that the acquisition operation that is an operation of acquiring at least one of the target item of the one or more items and the right to acquire the target item has been received. Upon acquisition of the acquisition operation information, the server 100 outputs an item acquisition complete image. For example, the server outputs, as the item acquisition complete image, an item presentation image that does not include the acquired item. Thus, the server changes an image that has been presented to a user to an image that does not include the item acquired by the user, so that it is possible to intuitively notify the user that the item has been acquired.

In a server according to an aspect 2 of the invention, in the aspect 1, the acquisition unit may further acquire selected item information indicating which item is selected from the one or more items indicated by the item presentation image, and when the acquisition unit acquires the selected item information, the image output unit may output an item selection complete image indicating that the item indicated by the selected item information is selected.

According to the aforementioned configuration, the server acquires the selected item information indicating the selected item and outputs the item selection complete image to the display device. For example, the server displays, as the item selection complete image, an item presentation image in which the selected item is highlighted. Thus, the server is able to intuitively notify the user that which item is selected.

In a server according to an aspect 3 of the invention, in the aspect 1 or 2, the acquisition unit may further acquire cancel information indicating that acquisition of at least one of the target item and the right to acquire the target item is to be canceled, and when the acquisition unit acquires the cancel information, the image output unit may output the item presentation image.

According to the aforementioned configuration, the server acquires the cancel information indicating that acquisition of the item is to be canceled and outputs the item presentation image. Thus, the server changes an image to be presented to the user from the item acquisition complete image to the item presentation image, so that it is possible to intuitively notify the user that the acquisition of the item is canceled.

In a server according to an aspect 4 of the invention, in any of the aspects 1 to 3, the acquisition operation receiving information acquired by the acquisition unit may be acquisition operation receiving information indicating that the display device (200 to 200d) including an antenna (NFC antenna 250) that performs near field radio communication with a mobile terminal (300 to 300d) has received the acquisition operation through the near field radio communication.

According to the aforementioned configuration, the server acquires the acquisition operation receiving information indicating that the acquisition operation has been received by performing the near field radio communication. Thus, the server enables the user to acquire a target item without requiring an unintuitive operation, such as pressing of a button, to acquire the target item.

In a server according to an aspect 5 of the invention, in the aspect 4, the acquisition operation may be an operation in which the mobile terminal is displaced from the antenna after the mobile terminal has been in proximity to the antenna.

According to the aforementioned configuration, the server enables the user to acquire a target item without requiring a troublesome operation.

In a server according to an aspect 6 of the invention, in the aspect 4 or 5, the acquisition unit may further acquire mobile terminal information that is information related to the mobile terminal, and the image output unit may output an item presentation image associated with the mobile terminal information to the display device.

According to the aforementioned configuration, the server acquires the mobile terminal information that is information associated with the mobile terminal that has performed the acquisition operation. Thus, for example, when an age of a user of the mobile terminal is included in the mobile terminal information, the server is able to output an item presentation image according to the age of the user, so that it is possible to present an item presentation image according to the user.

An item providing system (1 and 1b) according to an aspect 7 of the invention is an item providing system including a mobile terminal (300 and 300b), a display device (200 and 200b), and a server (100 and 100b), in which the mobile terminal includes an item acquisition unit (324) that acquires, with an acquisition operation that is an operation of acquiring at least one of a target item of one or more items and a right to acquire the target item, the item or the right to acquire the item from the display device; the display device includes an image acquisition unit (224) that acquires an item presentation image indicating the one or more items, an image display unit (display control unit 225) that displays, on a display unit (display device display unit 240), the item presentation image acquired by the image acquisition unit, an acquisition operation reception unit (NFC control unit 221) that receives the acquisition operation, and an information output unit (222) that, when the acquisition operation reception unit receives the acquisition operation, outputs acquisition operation receiving information indicating that the acquisition operation has been received; and the server includes an image output unit (124) that outputs the item presentation image to the display device, and an acquisition unit (information acquisition unit 121) that acquires the acquisition operation receiving information from the display device, and when the acquisition unit acquires the acquisition operation receiving information, the image output unit outputs an item acquisition complete image indicating that at least one of the target item and the right to acquire the target item has been acquired.

According to the aforementioned configuration, the item providing system exerts an effect similar to that of the server according to the aspect 1.

A display device according to an aspect 8 of the invention is the display device included in the item providing system in the aspect 7, and includes: an image acquisition unit that acquires the item presentation image indicating the one or more items; an image display unit that displays, on the display unit, the item presentation image acquired by the image acquisition unit; an acquisition operation reception unit that receives the acquisition operation; and an information output unit that, when the acquisition operation reception unit receives the acquisition operation, outputs acquisition operation receiving information indicating that the acquisition operation has been received.

According to the aforementioned configuration, the display device is able to realize the display device in the item providing system according to the aspect 7.

A display device (200e) according to an aspect 9 of the invention includes: an image display unit (display control unit 225) that displays, on a display unit (display device display unit 240), an item presentation image indicating one or more items; and an acquisition operation reception unit (NFC control unit 221) that receives an acquisition operation that is an operation of acquiring at least one of a target item of the one or more items and a right to acquire the target item, in which when the acquisition operation reception unit receives the acquisition operation, the image display unit displays, on the display unit, an item acquisition complete image indicating that at least one of the target item and the right to acquire the target item has been acquired.

According to the aforementioned configuration, the display device exerts an effect similar to that of the server according to the aspect 1.

A mobile terminal (300c, 300d) according to an aspect 10 of the invention includes: an acquisition operation detection unit (NFC control unit 325) that detects, through near field radio communication, an acquisition operation that is an operation of acquiring at least one of a target item of one or more items and a right to acquire the target item; and an item acquisition unit (324) that, when the acquisition operation detection unit detects the acquisition operation, acquires at least one of the target item and the right to acquire the target item.

According to the aforementioned configuration, the display device exerts an effect similar to that of the server according to the aspect 1.

The server, the display device, and the mobile terminal according to each of the aspects of the invention may be realized by a computer, and, in this case, a control program of the server, the display device, and the mobile terminal, which realizes the server, the display device, and the mobile terminal by causing the computer to operate as the respective units (limited to software elements) of the server, the display device, and the mobile terminal, and a computer readable recording medium in which the control program is recorded also fall within the scope of the invention.

The invention is not limited to each of the embodiments described above and can be modified variously within the scope defined by the claims, and embodiments obtained by appropriately combining technical means disclosed in different embodiments are also included in the technical scope of the invention. Further, by combining the technical means disclosed in each of the embodiments, a new technical feature may be formed.

### INDUSTRIAL APPLICABILITY

The invention is able to be used for an item providing system that provides an item such as an electronic coupon.

### REFERENCE SIGNS LIST

1, 1a, 1b, 1c, 1d, 1e item providing system
100, 100a, 100b, 100c, 100d server
110 server communication unit
120 server control unit
121 information acquisition unit (acquisition unit)
122 item management unit
123 item output unit
124 image output unit
130 item storage unit
200, 200a, 200b, 200c, 200d, 200e display device
210 display device communication unit 210
220, 220e display device control unit
221 NFC control unit
222 information output unit
223 item acquisition unit
224 image acquisition unit
225 display control unit (image display unit)
226 item management unit
230 item storage unit
240 display device display unit (display unit)
250 NFC antenna (antenna)
300, 300a, 300b, 300c, 300d, 300e mobile terminal
310 mobile terminal communication unit
320 mobile terminal control unit
321 display control unit
323 operation signal acquisition unit
324 item acquisition unit
325 NFC control unit (acquisition operation detection unit)
326 terminal information management unit
340 mobile terminal display unit
350 NFC-I/F unit
360 operation reception unit

1. A server, comprising:
an image output unit that outputs, to a display device, an item presentation image indicating one or more items; and
an acquisition unit that acquires acquisition operation receiving information indicating that the display device has received an acquisition operation that is an operation of acquiring at least one of a target item of the one or more items and a right to acquire the target item, wherein
when the acquisition unit acquires the acquisition operation receiving information, the image output unit outputs an item acquisition complete image indicating that at least one of the target item and the right to acquire the target item has been acquired.

2. The server according to claim 1, wherein
the acquisition unit further acquires selected item information indicating which item is selected from the one or more items indicated by the item presentation image, and
when the acquisition unit acquires the selected item information, the image output unit outputs an item selection complete image indicating that the item indicated by the selected item information is selected.

3. The server according to claim 1, wherein
the acquisition unit further acquires cancel information indicating that acquisition of at least one of the target item and the right to acquire the target item is to be canceled, and
when the acquisition unit acquires the cancel information, the image output unit outputs the item presentation image.

4. The server according to claim 1, wherein
the acquisition operation receiving information acquired by the acquisition unit is acquisition operation receiving information indicating that the display device including an antenna that performs near field radio communication with a mobile terminal has received the acquisition operation through the near field radio communication.

5. The server according to claim 4, wherein
the acquisition operation is an operation in which the mobile terminal is displaced from the antenna after the mobile terminal has been in proximity to the antenna.

6. The server according to claim 4, wherein
the acquisition unit further acquires mobile terminal information that is information related to the mobile terminal, and
the image output unit outputs an item presentation image associated with the mobile terminal information to the display device.

7. A non-transitory computer-readable recording medium in which a program for causing a computer to serve as units of a server recited in claim 1 is recorded.

8. (canceled)

9. (canceled)

10. A display device, comprising:
an image display unit that displays, on a display unit, an item presentation image indicating one or more items; and
an acquisition operation reception unit that receives an acquisition operation that is an operation of acquiring at least one of a target item of the one or more items and a right to acquire the target item, wherein
when the acquisition operation reception unit receives the acquisition operation, the image display unit displays, on the display unit, an item acquisition complete image indicating that at least one of the target item and the right to acquire the target item has been acquired.

11. A non-transitory computer-readable recording medium in which a program for causing a computer to serve as units of a display device recited in claim 10 is recorded.

12. A mobile terminal, comprising:
an acquisition operation detection unit that detects, through near field radio communication, an acquisition operation that is an operation of acquiring at least one of a target item of one or more items and a right to acquire the target item; and
an item acquisition unit that, when the acquisition operation detection unit detects the acquisition operation, acquires at least one of the target item and the right to acquire the target item.

13. A non-transitory computer-readable recording medium in which a program for causing a computer to serve as units of a mobile terminal recited in claim 12 is recorded.
